(19) United States
(12) Patent Application Publication
(10) Pub. No.: US 2026/0271064 A1
(43) Pub. Date: Sep. 10, 2026

(54) RESOLVING RESOURCE CONTENTION BETWEEN DIFFERENT PERIODIC DATA TRANSMISSIONS

(71) Applicant: SHARP KABUSHIKI KAISHA, Sakai City, Osaka (JP)

(72) Inventors: Kenneth James Park, Vancouver, WA (US); ZHANPING YIN, Vancouver, WA (US)

(21) Appl. No.: 18/880,364

(22) PCT Filed: Jun. 7, 2023
(86) PCT No.: PCT/JP2023/021093

§ 371 Date: Dec. 31, 2024

Related U.S. Application Data
(60) Provisional application No. 63/388,976, filed on Jul. 13, 2022.

(51) Int. Cl. H04W 74/0816; H04L 5/00; H04W 64/00

(52) U.S. Cl. CPC H04W 74/0816; H04L 5/0048; H04L 5/0069; H04L 5/0082; H04W 64/00

(57) ABSTRACT

A method for a terminal device of a New Radio (NR) system is provided. The method includes determining whether contention will exist between transmission of a first periodic data and transmission of a second periodic data in a transmission resource; and when contention will exist between transmission of the first periodic data and transmission of the second periodic data in the transmission resource, selecting one of the first periodic data and the second periodic data for transmission in the transmission resource, and transmitting the selected one of the first periodic data and the second periodic data in the transmission resource.

### TECHNICAL FIELD

The present disclosure generally relates to wireless communications and, more specifically, to resolving contention for resources between different periodic data transmissions in a wireless network (e.g., a fifth generation (5G) (e.g., New Radio (NR)) network).

### BACKGROUND ART

The 3rd Generation Partnership Project (3GPP) (e.g., as indicated in Release 17 (Rel-17) of 3GPP) has conducted studies relating to “NR positioning enhancements” and “scenarios and requirements of in-coverage, partial coverage, and out-of-coverage NR positioning use cases.”

The study regarding NR positioning enhancements investigated higher accuracy and lower latency location determination, particularly in view of high integrity and reliability requirements resulting from new applications and industry verticals for 5G. Some of the enhancements identified during this work have been specified in the 3GPP Rel-17 Work Item (WI) on “NR Positioning Enhancements,” but several opportunities for enhancement remain that are yet to be studied and/or released in any of the 3GPP specifications.

The study relating to scenarios and requirements of in-coverage, partial coverage, and out-of-coverage NR positioning use cases focuses on vehicle-to-everything (V2X) features and public safety use cases (e.g., where the outcome has been captured in Technical Report (TR) 38.845). Additionally, the 3GPP Technical Specification Group (TSG) Service and System Aspects (SA) Working Group 1 (WG1) (more commonly known as “SA1”) has developed requirements in Technical Specification (TS) 22.261 for “ranging-based services” and has developed positioning accuracy requirements in TS 22.104 for Industrial Internet of Things (IIoT) use cases (e.g., in out-of-coverage scenarios). However, there remains a need for 3GPP to study and develop sidelink (SL) positioning solutions that can support the use cases, scenarios, and requirements identified during such activities.

Regarding higher accuracy, promising techniques identified in earlier studies may be considered in the 3GPP Rel-18 study (e.g., the “Study on expanded and improved NR positioning (Acronym: FS_NR_pos_enh2), as discussed in 3GPP Radio Access Network (RAN) Work Item Description (WID) RP-213588). One aspect of the study looks to take advantage of the rich 5G spectrum to increase the bandwidth for the transmission and reception of Positioning Reference Signals (PRSs). That is, enhancements to positioning techniques may be achieved by taking advantage of the wider bandwidths provided by NR, for example, by way of Frequency Range 1 (FR1) (e.g., below 6 gigahertz (GHz)) and FR2 (e.g., the millimeter wave range of 24.25 to 52.6 GHz), such that different PRSs may be allocated to resources that may be transmitted and/or received by both a base station (e.g., Next Generation NodeB (gNB)) and a user equipment (UE).

As described in greater detail below, in employing such positioning enhancements, a single NR V2X UE may be configured with multiple active uplink (UL) Configured Grants (CGs) for transmission of corresponding PRSs. Moreover, a gNB may allocate a set of transmission resources (e.g., the time domain and frequency domain resources used to transmit data) for each corresponding CG. In some situations, the transmission resources for different CGs may partially or wholly overlap, thus creating contention for those resources within the UE.

### SUMMARY OF INVENTION

In one example, a terminal device for resolving contention between first periodic data and second periodic data being transmitted by the terminal device in a New Radio (NR) system, the terminal device comprising: one or more non-transitory computer-readable media storing a set of computer-executable instructions; and at least one processor coupled to the one or more non-transitory computer-readable media and configured to execute the set of computer-executable instructions to: determine whether contention will exist between transmission of the first periodic data and transmission of the second periodic data in a transmission resource; and when contention will exist between transmission of the first periodic data and transmission of the second periodic data in the transmission resource, select one of the first periodic data or the second periodic data for transmission in the transmission resource, and transmit the selected one of the first periodic data or the second periodic data in the transmission resource.

### BRIEF DESCRIPTION OF DRAWINGS

Implementations of the present technology will now be described, by way of example only, with reference to the attached figures.

FIG. 1A is a diagram illustrating a transmission pattern of a PRS and a transmission pattern of a Sounding Reference Signal (SRS), respectively, according to an example implementation of the present disclosure.

FIG. 1B is a diagram illustrating a transmission pattern of a PRS and a transmission pattern of a Sounding Reference Signal (SRS), respectively, according to an example implementation of the present disclosure.

FIG. 2 is a timing diagram illustrating transmission resources of two periodically overlapping Configured Grants (CGs) assigned to a device, according to an example implementation of the present disclosure.

FIG. 3A is a time-frequency diagram illustrating transmission resources of slots allocated by two periodically overlapping CGs assigned to a device, according to an example implementation of the present disclosure.

FIG. 3B is a time-frequency diagram illustrating transmission resources of slots allocated by two periodically overlapping CGs assigned to a device, according to an example implementation of the present disclosure.

FIG. 3C is a time-frequency diagram illustrating transmission resources of slots allocated by two periodically overlapping CGs assigned to a device, according to an example implementation of the present disclosure.

FIG. 4 is a flowchart illustrating a method of configuring a device and employing that configuration to perform a selection process between different periodic data transmissions, according to an example implementation of the present disclosure.

FIG. 5 is a flowchart illustrating a method for a selection process for selecting between different periodic data transmissions, according to an example implementation of the present disclosure.

FIG. 6 is a flowchart illustrating a method for a Quality of Service (QoS)-based selection process for selecting between different periodic data transmissions, according to an example implementation of the present disclosure.

FIG. 7 is a block diagram illustrating a node for wireless communication, according to an example implementation of the present application.

### DESCRIPTION OF EMBODIMENTS

The 3GPP is a collaboration agreement that aims to define globally applicable technical specifications and technical reports for third and fourth generation wireless communication systems. The 3GPP may also define specifications for next generation mobile networks, systems, and devices.

3GPP Long-Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), and other standards (e.g., 3GPP Releases 8, 9, 10, 11, 12, 13, 14, 15, and so on) including New Radio (NR), which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station (BS), which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices may include cellular phones, smart phones, personal digital assistants (PDAs), laptop computers, netbooks, e-readers, wireless modems, etc.

In the 3GPP specifications, a wireless communication device may typically be referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a BS is typically referred to as a NodeB, an evolved NodeB (eNB), a home enhanced or evolved NodeB (HeNB), a Next Generation NodeB (gNB), or some other similar terminology. As the scope of the disclosure should not be limited to 3GPP standards, the terms “base station,” “NodeB,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and/or gNB may also be more generally referred to as a base station device.

It should be noted that, as used herein, a “cell” may be any communication channel that is specified by standardization or regulatory bodies to be used for International Mobile Telecommunications-Advanced (IMT-Advanced), and all of IMT-Advanced, or a subset thereof, may be adopted by 3GPP as licensed bands (e.g., frequency bands) to be used for communication between an eNB and a UE. It should also be noted that in the E-UTRA and E-UTRAN overall description, as used herein, a “cell” may be defined as a “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB and/or gNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and, in the case of a downlink transmission, those cells for which the UE decodes a physical downlink shared channel (PDSCH). “Deactivated cells” are those configured cells for which the UE is not monitoring the transmission of PDCCH. It should be noted that a “cell” may be described in terms of differing dimensions. For example, a “cell” may have temporal, spatial (e.g., geographical), and frequency characteristics.

The 5G communication systems, dubbed NR technologies by the 3GPP, envision the use of time/frequency/space resources to allow for services, such as Enhanced Mobile Broadband (eMBB) transmission, Ultra-Reliable Low-Latency Communications (URLLC) transmission, and massive Machine Type Communication (mMTC) transmission. Also, in NR, single-beam and/or multi-beam operations are considered for downlink and/or uplink transmissions.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Therefore, the detailed description of the present disclosure as illustrated in the figures is not intended to limit the scope of the present disclosure but is merely representative of the systems and methods.

As mentioned above, a UE may be configured to transmit more than one type of periodic transmission, wherein the multiple periodic transmission types may compete for at least some of the same transmission resources. For example, in employing enhanced positioning techniques, a single NR V2X UE may be configured with multiple UL CGs for transmission of corresponding PRS types. Additionally, a gNB may allocate a set of transmission resources (e.g., the time domain and frequency domain resources used to transmit data) for each corresponding CG. Consequently, the transmission resources for different CGs may partially or wholly overlap, thus potentially creating resource contention for those resources within the UE.

According to various implementations of the present disclosure, a mechanism is discussed by which a UE may select which of multiple periodic transmission types will use the particular set of transmission resources for which contention exists between periodic transmission types. In some examples, the process by which such a selection may be configured (e.g., by the network (NW) with which the UE is communicatively coupled, by a preexisting configuration stored in the UE, and the like). For the purposes of this disclosure, the term “periodic” may refer to the repeating nature of an event that occurs at some constant interval. The term “periodicity” refers to the interval at which the periodic event occurs, such as in units of a length of time that has elapsed from a first event (e.g., “n”) to the next event (e.g., “n+1”).

### NR Frame Structure

The 5G NR Frame structure is described in the NR 3GPP standards (e.g., Technical Specification (TS) 38.211). The 5G NR frame structure includes subframes, slots, and symbol configurations. As described above, the 5G NR Supports two frequency ranges: FR1 (which is under 6 gigahertz (GHz)) and FR2 (also known as millimeter wave range, which is between 24.25 GHz to 52.6 GHZ). NR uses flexible subcarrier spacing derived from basic 15 kilohertz (kHz) subcarrier spacing that is also used in the LTE. A frame may have a duration of 10 milliseconds (ms) which may consist of 10 subframes each having 1 ms duration, which is similar to the LTE networks. Each subframe may have 2ª slots (u being a member of the set of [0 . . . 4]). Each slot may typically consist of 14 orthogonal frequency division multiplexing (OFDM) symbols. The number of symbols, however, may dependent upon the start and length indicator value (SLIV). The radio frames of 10 ms may be transmitted continuously one after the other as per Time Division Duplex (TDD) topology. A subframe may be of a fixed duration (e.g., 1 ms) whereas a slot's length may vary based on a subcarrier spacing (SCS) and the number of slots per subframe. A slot is 1 ms for 15 kHz, 500 us for 30 kHz, and so on. The subcarrier spacing of 15 kHz may occupy one slot per subframe, whereas the subcarrier spacing of 30 kHz may occupy two slots per subframe, and so on. Each slot may occupy either 14 OFDM symbols or 12 OFDM symbols depending on the normal cyclic prefix (CP) or extended CP, respectively.

It should be noted that even though for the remainder of this disclosure, a 14-symbol configuration that is based on a normal CP is discussed, a 12-symbol configuration that is based on an extended CP may not be precluded from the solution space.

In 5G, a resource grid (RG) is the grouping of uplink (UL) or downlink (DL) resources at the physical layer of a given numerology (described below). The time domain is usually expressed as symbols of a slot, and as slots of a subframe, and the frequency domain is typically expressed as the available resource block (RB) (also described below) within the transmission bandwidth.

In 5G, a resource element (RE) is the smallest physical resource in NR which may include one subcarrier during one OFDM symbol. Also, in 5G, one NR Resource Block (RB) may contain 12 sub-carriers in the frequency domain, irrespective of the numerology, and is defined only in the frequency domain (e.g., the bandwidth may not be fixed and may be dependent upon the configured sub-carrier spacing). Additionally, in 5G, Physical Resource Blocks (PRBs) are the RBs that are used for actual/physical transmission/reception.

### NR Numerology

Numerology is a term used in the 3GPP specification to describe the different subcarrier spacing types, as there are several different types of subcarrier spacing as summarized in the following Table 1 (which is similar to the Table 4.2-1 in TS 38.211) that defines the supported transmission numerologies.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

It should be noted that for the remainder of this disclosure, the terms numerology and subcarrier spacing (SCS) may be used interchangeably. It should also be noted that the term “SCS configuration factor n” may be used to refer to a subcarrier spacing type, where n may belong to the set [0,1,2,3,4], as noted in the table above and is referred to as μ.

### Physical Layer Design for Nr V2X Sidelink

The physical layer structure for the NR V2X sidelink is based on the Rel. 15 NR interface (Uu) design. In addition, the physical layer procedures for the NR V2X sidelink (SL) may reuse some of the concepts of Rel. 14 LTE V2X, with the introduction of additional procedures for providing physical layer support for unicast and groupcast transmissions.

### Positioning Reference Signals

To enable more accurate positioning measurements than LTE, new dedicated reference signals are added to the NR Rel-16 specifications with a high Resource Element (RE) density and with the correlation properties that are better than existing reference signals due to the diagonal or staggered reference signal patterns. In the downlink, the new signal is known as the “NR Positioning Reference Signal” (may also be known as NR PRS, or only PRS) and in the uplink, the new signal is known as the “Sounding Reference Signal” (SRS) for positioning (e.g., determining the location of a UE).

It should be noted that in releases prior to the 3GPP Rel-16, an SRS may also be defined and used by the base station to estimate the quality of the uplink channel for the large bandwidths outside the assigned span to a specific UE. However, the prior release's SRS may have limitations on its density of use in the time domain that do not apply to the Rel-16 SRS for positioning. As such, the SRS for positioning and the SRS for channel quality estimation are configured separately and with different properties specific to their usage. Thus, for the remainder of this disclosure, any reference to an SRS may apply to the SRS for positioning.

### Downlink PRS Signal

In the downlink (DL) transmissions, a dedicated Positioning Reference Signal (PRS) for positioning (e.g., determining the location of a UE) purposes is specified in the 3GPP Rel-16. The PRS may include a pseudo-random sequence that is modulated by Quadrature Phase Shift Keying (QPSK). The pseudo-random sequence may include a Gold sequence of length 31. The PRS is described in more detail in the 5G standard in TS 38.211. The generation of PRS may include two steps: generation of PRS sequences based on Gold sequences and the PRS mapping.

### Uplink SRS Signal

In the uplink (UL) transmissions, there is not any dedicated pilot for positioning, so the Sounding Reference Signal (SRS) may be selected for this purpose. In the 5G NR, the SRS generation is implemented according to the 3GPP TS 38.211. The uplink 5G NR sounding reference signal (NR-SRS) sent by the UE may be an OFDM modulated Zadoff-Chu sequence that is feasible for time delay estimation. Similar to the generation of the PRS, the generation of the SRS may also include two steps: Zadoff-Chu sequence generation and the SRS mapping.

### Mapping a Positioning Reference Signal

A UE may be configured with one or more downlink PRS positioning frequency layer configurations. A PRS positioning frequency layer may be defined as a collection of PRS resource sets with each PRS resource set defining a collection of PRS resources. All the PRS resource sets defined in the PRS positioning frequency layer may be configured with a Subcarrier Spacing parameter and a Cyclic Prefix parameter, as described below.

The subcarrier spacing for all PRS resource sets in a PRS positioning frequency layer may be specified as 15, 30, 60, or 120 kHz. The SubcarrierSpacing parameter property in the nrCarrierConfig object may be used to set the subcarrier spacing of a PRS resource set.

The cyclic prefix for all PRS resource sets in a PRS positioning frequency layer may be specified as “normal” or “extended”. The CyclicPrefix parameter property of the nrCarrierConfig object may be used to set the cyclic prefix of a PRS resource set.

The lowest (or absolute) subcarrier of a reference resource block or common resource block may be known as “PRS Point A”. The 5G specification defines the PRS frequency resource allocation relative to PRS Point A.

To transmit the SRS in the 5G NR frames, the generated Zadoff-Chu sequence may be mapped to the given physical resources (e.g., which may include subcarriers and time slots). The mapping description may be found in chapter 6.4.1.4.3 of the 3GPP TS 38.211 specification.

The downlink positioning reference signal (PRS) is the main reference signal supporting downlink-based positioning methods. Although other signals may be used, the PRS is specifically designed to deliver the highest possible level of accuracy, coverage, and interference avoidance and suppression. The PRS signal provides a large delay spread range, since it must be received from potentially distant neighboring base stations for position (e.g., of a UE) estimation. This may be achieved by covering the whole NR bandwidth and transmitting the PRS over multiple symbols which may be aggregated to accumulate power. The duration of a PRS may be associated with the duration of a symbol that is used to transport the PRS, and the duration of such a symbol may be associated with the Subcarrier Spacing (SCS) configuration (aka the Numerology) that is used to define the carrier configuration parameters for a specific OFDM numerology, where such a Numerology may describe the time and frequency of waveforms used by the Resource Blocks (RB) of an NR carrier.

In NR, the density of subcarriers occupied in a given PRS symbol may be referred to as a comb size. There are several configurable comb-based PRS patterns (e.g., comb-2, -4, -6, and -12) that are suitable for different scenarios serving different use cases. For a comb-N PRS, N symbols may be combined to cover all the subcarriers in the frequency domain. By assigning a different comb set to different base stations, each base station (BS) may transmit in a different set of subcarriers to avoid interference. Since several base stations may transmit at the same time without interfering with each other, such a solution may also be latency efficient. For use cases with higher transmission loss, the PRS may also be configured to be repeated to improve the potential for a two-level reception: within a single slot and across multiple slots. Some implementations may configure the starting resource element (e.g., in the time and frequency domains) from a transmission-reception point (TRP) for a reception within a single slot. Some implementations may configure the gaps between the PRS slots, their periodicity and density (e.g., within a period), for a reception across multiple slots.

### Multiplexing PRS in a Slot

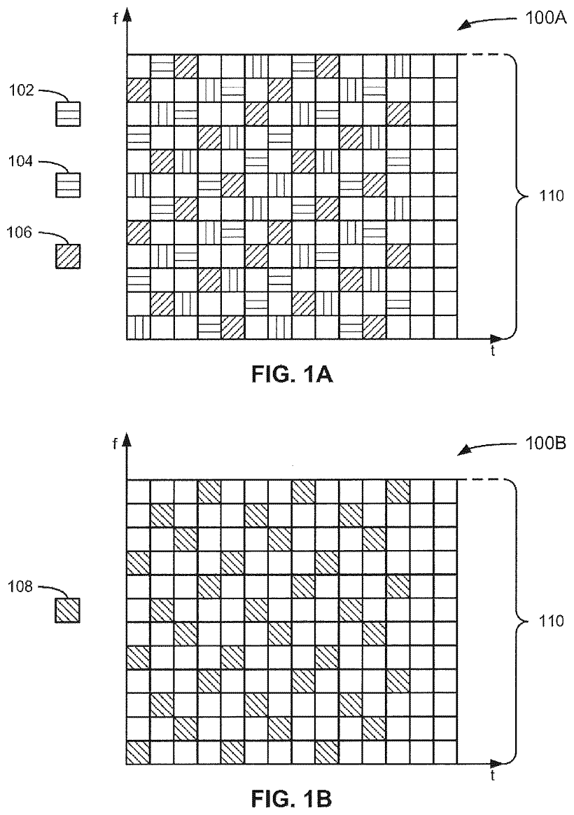

The density of a subcarrier occupied in a given PRS symbol may be referred to as the comb size. There are several configurable comb-based PRS patterns for comb-2, -4, -6, and -12 that are suitable for different scenarios serving different use cases. The pattern shown in FIG. 1A below corresponds to a comb-6 with three base stations multiplexed over one slot duration.

FIGS. 1A and 1B are diagrams illustrating a transmission pattern of a PRS and a transmission pattern of an SRS, respectively, according to an example implementation of the present disclosure. Specifically, FIG. 1A illustrates a time-frequency resource grid 100A in which a PRS transmission pattern (e.g., transmitted from three different base stations) in a physical resource block (PRB) 110 is shown. FIG. 1B, on the other hand, illustrates a time-frequency resource grid 100B in which a single SRS pattern (e.g., transmitted by a UE) in a PRB 110 is shown. Specifically, FIG. 1B illustrates SRS 108, which is transmitted by a UE (not shown in the figure) in a set of symbols of the resource block. In FIGS. 1A and 1B, each individual block within PRB 110 may be a resource element (RE) associated with a particular subcarrier and a particular symbol number of the slot.

For a comb-3 PRS, which is the case shown in FIG. 1A, three different symbols may be combined to cover all the subcarriers in the frequency domain. Each base station may then transmit, as shown in the figure, in different sets of subcarriers (or different sets of symbols of each subcarrier) to avoid interference with the PRS signals belonging to the other two base stations. For example, as shown in FIG. 1A, the first base station (not shown in the figure) may transmit PRS 102 in a first set of symbols, while the second base station (not shown in the figure) may transmit PRS 104 in a second set of symbols, and the third base station (not shown in the figure) may transmit PRS 106 in a third set of symbols. In some implementations, in general, for a comb-N PRS (N being a positive number), N symbols may be combined to cover all the subcarriers in the frequency domain.

In some implementations, the following parameters/properties of a configured object (e.g., the nrPRSConfig object) may control the PRS slot configuration. One property may be the PRSResourceSetPeriod property, which may indicate the slot periodicity and offset (0-based) of a PRS resource set. Another property may be the PRSResourceOffset property, which may indicate the slot offset (0-based) of each PRS resource defined relative to the slot offset of the PRS resource set. Another property may be the PRSResourceRepetition property, which may indicate the repetition factor of all PRS resources in a PRS resource set. Another property may be the PRSResourceTimeGap property, which may indicate the slot offset between two consecutive repetition indices of all PRS resources in a PRS resource set.

For UL transmission, an SRS configuration object, such as the nrSRSConfig object, may set the SRS configuration parameters (e.g., similar to what is defined in the 3GPP TS 38.211). The default nrSRSConfig object may specify a single-port, single-symbol, narrowband configuration without frequency hopping and may place the SRS at the end of the slot.

In the uplink direction, the SRS for positioning may resolve two aspects specific to positioning. Since positioning involves measurements (e.g., from multiple receiving base stations), the SRS may have enough range to reach not only the serving base station (e.g., to which the UE is connected), but also the neighboring base stations that are involved in the positioning process. The SRS may also be designed to cover the full bandwidth, where the resource elements are spread across different symbols, such as to cover all subcarriers. Therefore, the SRS may also be designed with a comb-based pattern similar to the PRS. The different UEs signals may be multiplexed over the same transmitting symbol by assigning different comb patterns. To minimize the interference, a UE may be configured with different SRS instances, each having independent power control loops. This may allow the SRS pointed at neighboring cells to have better “hearability” (or reception) and may keep the interference low in the serving cell. As discussed above, an example SRS 108 transmitted by a UE is shown in FIG. 1B.

### Maximum Bandwidth

The PRS footprint on the NR time-frequency grid may be configurable with a starting physical resource block (PRB) and a PRS bandwidth. The PRS may start at any PRB in the system bandwidth and may be configured with a bandwidth ranging from 24 to 276 PRBs in steps of four PRBs. This amounts to a maximum bandwidth of about 100 MHz for a 30-kHz subcarrier spacing (30 kHz/subcarrier×12 subcarrier/PRB×276 PRB=99.360 MHz) and to about 400 MHz for a 120-kHz subcarrier spacing. The large bandwidth in 5G NR provides for a significant improvement in the time-of-arrival (TOA) accuracy compared to LTE. The maximum bandwidth in the NR V2X SL may depend on the SCS. Additionally, only one numerology (e.g., one combination of SCS and CP) may be used in a carrier at a time in the NR V2X SL.

To support UEs that cannot handle large bandwidths (e.g., due to processing limitations or high-power consumption), the concept of bandwidth part (BWP) has been introduced. A BWP may be a subset of the 100 MHz maximum bandwidth that may be configured for a 30-kHz SCS, such as in FR1, or a subset of the 400 MHz maximum bandwidth configured for a 120-kHz SCS, such as in FR2.

### Bandwidth Part

In 5G, a BWP may be a subset of contiguous common resource blocks for a given numerology. A UE may be configured with up to four DL BWPs and up to four UL BWPs for each serving cell. Per serving cell, only one BWP in the DL and one BWP in the UL may be activated at a given time (e.g., one SL BWP may be active for all the UEs in a serving cell). For the downlink, the UE may not be expected to receive outside an active BWP (e.g., except for Radio Resource Management purposes). For the uplink, the UE may not transmit outside an active BWP and for an active cell, the UE may not transmit SRSs outside an active BWP. As the sidelink transmissions and receptions of a UE are contained within the SL BWP and employ the same numerology, all physical channels, reference signals, and synchronization signals in NR V2X sidelink are transmitted within the SL BWP. This also means that the sidelink UE may not be expected to receive or transmit in a carrier with more than one numerology. In 5G, physical resource blocks (PRBs) are the RBs which are used for actual transmission/reception. A set of PRBs may belong to a single BWP. PRBs of a BWP may be numbered from 0 to a threshold size (e.g., the size of a BWP minus 1). Each BWP may have its own set of PRBs.

While the NR specification provides that NR V2X capable UEs may use multiple carrier bandwidths, where the carrier bandwidths may occupy FR1, or FR2, or both FR1 and FR2 bands, the configuration of an SL BWP to a carrier bandwidth requires that all the SL BWPs configured in a carrier bandwidth use the same numerology. As such, an SL BWP of a Carrier Bandwidth of FR1 may not have the same numerology as an SL BWP of a Carrier Bandwidth of FR2 (e.g., except for an SCS of 60 kHz, which may be valid in both FR1 and FR2).

### Sidelink Bandwidth Part (SL BWP)

A SL BWP may occupy a contiguous portion of the bandwidth within a carrier. In a carrier, only one SL BWP may be configured for all the UEs. Sidelink transmissions and receptions of a UE may be contained within the SL BWP and may employ the same numerology. Thus, all physical channels, reference signals, and synchronization signals in NR V2X sidelink are transmitted within the SL BWP. This also means that in the sidelink, a UE is not expected to receive or transmit in a carrier with more than one numerology. The SL BWP may be divided into common RBs. A common RB may consist of 12 consecutive subcarriers with the same SCS, where the SCS may be given by the numerology of the SL BWP.

### Resource Pools

In NR V2X, only certain slots are configured to accommodate SL transmissions. Thus, the available sidelink resources may consist of slots that are allocated for sidelink (time resources) and common RBs within an SL BWP (frequency resources). In NR V2X, a subset of the available SL resources may be configured to be used by several UEs for their SL transmissions. This subset of available SL resources may be referred to as a resource pool. The common resource blocks within a resource pool are referred to as physical resource blocks (PRBs). A resource pool consists of contiguous PRBs and contiguous or non-contiguous slots that have been configured for SL transmissions. A resource pool may be defined within the SL BWP. Therefore, a single numerology may be used within a resource pool. If a UE has an active UL BWP, the SL BWP may use the same numerology as the UL BWP (e.g., if they are both included in the same carrier).

### Resource Pools in the Frequency Domain

A resource pool may be divided into a configured number of contiguous subchannels, where a sub-channel consists of a group of consecutive PRBs in a slot. The number of PRBs in a sub-channel may correspond to the sub-channel size, which may be configured within a resource pool. In NR V2X SL, the sub-channel size may be equal to 10, 12, 15, 20, 25, 50, 75, or 100 PRBs. A sub-channel may represent the smallest unit for a sidelink data transmission or reception. A sidelink transmission may use one or multiple sub-channels.

### Resource Pools in the Time Domain

The slots that are part of a resource pool may be configured and occur with a periodicity of 10,240 ms. In the time domain, the resources (e.g., slots) available for sidelink may be determined by repeating the sidelink bitmaps. The length of a bitmap may be equal to 10 bits, 11 bits, 12 bits, . . . , 160 bits. In the case of TDD communications, the resources available for sidelink may be given by a combination of the TDD pattern and the sidelink bitmap. At each slot of a resource pool, only a subset of consecutive symbols may be configured for the sidelink out of the 14 symbols per slot for a normal CP. The number of consecutive SL symbols may vary between 7 to 14 symbols depending on the physical channels that is carried within a slot.

### Resource Pool Allocations: MODE1 and MODE2

In 5G, two different modes (i.e., MODE1 and MODE2) are used for the selection of sub-channels in NR V2X SL communications (e.g., when using the NR V2X PC5 interface). MODE1 and MODE2 may be equivalent to MODE3 and MODE4 in LTE V2X, but may be extended to include functionality in support of groupcast and unicast communications over NR V2X SL. MODE1 refers to a centralized resource allocation via a base station (e.g., a gNB). The BS may schedule MODE1 type sidelink resources to be used by the UE for sidelink transmissions. MODE1 may apply to scenarios in which the various UEs may be inside the coverage of the BS. MODE2 may refer to autonomous allocations determined via the UE. With MODE2, the UE may autonomously determine the sidelink transmission resources within the sidelink resources configured by the BS (e.g., a gNB) or preconfigured by the network. MODE2 may apply to scenarios in which the various UEs maybe inside the coverage of the gNB, or outside the coverage of the gNB, or both.

The SL radio resources may be configured such that MODE1 and MODE2 use separate resource pools. The alternative may be that MODE1 and MODE2 share the same resource pool. In this alternative scenario, MODE1 UEs may notify MODE2 UEs of the resources allocated for their future transmissions to avoid collision of shared resources.

### MODE1 Resource Scheduling

MODE1 may use either a dynamic grant (DG) type of scheduling or a configured grant (CG) type of scheduling. With DG, MODE1 UEs may request the gNB to allocate resources for the transmission of every single Transport Block (TB), for example, via a Scheduling Request (SR) sent to the gNB (e.g., using the PUCCH). The gNB may respond (e.g., with downlink control information (DCI) over the PDCCH) to indicate to the UE the SL resources (e.g., the slot(s) and sub-channel(s)) allocated for the transmission of a TB (and up to 2 possible retransmissions of this TB).

With CG scheduling, MODE1 UEs may request the gNB to allocate resources for the transmission of several TBs by first sending to the gNB a message with UE assistance information that includes information about the expected SL traffic such as: periodicity of TBs, TB maximum size and quality of service (QoS) information. This information may be used by the gNB to create, configure, and allocate a CG to the UE that may satisfy the requirements of the SL traffic. The CG may be configured using a set of parameters that may include the CG index, the time-frequency allocation, and the periodicity of the allocated SL resources. A UE may be assigned a maximum number of three SL resources during each period of the CG.

For CG scheduling, there may be two types of allocation schemes for SL: CG type 1 and CG type 2. CG type 1 allocations may be utilized by the UE immediately and until it is released by the base station. CG type 2 allocations may be used only after it is activated by the gNB and until it is deactivated. The gNB notifies the UE of the activation and deactivation of type 2 CG allocations (e.g., using DCI signaling). The DCI may also include the CG index and the time-frequency allocation of a type 2 CG. A type 2 CG may configure multiple CGs for a UE and may only activate a subset of the CGs based on the UE's needs.

### MODE2 Resource Scheduling

NR V2X UEs may autonomously select their SL resources (e.g., one or several subchannels) from a resource pool when using MODE2. MODE2 UEs may operate without a network coverage. A MODE2 resource pool may be configured by the gNB when the UE is in network coverage. A MODE2 UE may operate using a dynamic or a semi-persistent scheduling scheme. The dynamic scheme only selects resources for a TB while the semi-persistent scheme selects resources for a number of consecutive Reselection Counter TBs.

The dynamic scheme selects new resources for each TB and may only reserve resources for the retransmissions of that TB. A reserved resource, in some implementations, may be a selected resource that a UE reserves for a future transmission (e.g., by notifying the neighboring UEs using the 1st-stage SL control information (SCI)).

The semi-persistent scheme selects and reserves resources for the transmission of several TBs (and their retransmissions). The time period between the resources selected for the transmission of consecutive TBs in the semi-persistent scheme may be defined by the Resource Reservation Interval (RRI). The selected RRI may also determine the Reselection Counter that may be randomly set within an interval that depends on the selected RRI.

To select new SL resources for both dynamic and semi-persistent schemes, a UE first defines the selection window where it looks for candidate resources to transmit a TB. Once the selection window is defined, the UE may identify the candidate resources within the selection window. A candidate resource may be defined by a slot in the time domain and L_{PSSCH} contiguous sub-channels in the frequency domain (L_{PSSCH} is the number of contiguous Physical Sidelink Shared Channels (PSSCH) in the frequency domain).

### NR V2X Sidelink Numerology

The frequencies in which NR V2X sidelink may operate are within the two following frequency ranges: (i) Frequency range 1 (FR1): 410 MHz to 7.125 GHZ, and (ii) Frequency range 2 (FR2): 24.25 GHz to 52.6 GHz. To support diverse requirements and different operating frequencies in FR1 and FR2, a scalable OFDM numerology may be provided for NR V2X (e.g., based on Rel. 15 NR Uu). Each OFDM numerology may be defined by a Subcarrier Spacing (SCS) and a Cyclic Prefix (CP). NR V2X supports multiples of 15 kHz for the SCS of the OFDM waveform. Different OFDM numerologies may be obtained with a scalable SCS given by 2^{μ}×15 kHz, where μ is an SCS configuration factor. For NR V2X, the SCS configuration factor may be μ=0, 1, 2, 3, such that the SCS may be equal to 15 kHz, 30 kHz, 60 kHz, or 120 kHz. In FR1, 15 kHz, 30 kHz, and 60 kHz may be supported for the SCS, while 60 kHz and 120 kHz may be supported for the SCS in FR2. It should be noted that only the 60 kHz SCS configuration may be supported in both FR1 and FR2.

### NR V2X Sidelink Physical Layer Structure

Transmissions in NR V2X SL use the orthogonal frequency division multiplexing (OFDM) waveform with a CP. The sidelink frame structure may be organized in radio frames (also may be referred as frames), each with a duration of 10 ms. A radio frame may be divided into 10 subframes, each with a duration of 1 ms. The number of slots per subframe and the SCS for the OFDM waveform may be flexible for NR V2X (e.g., a subframe may have 1, 2, 4, or 8 slots per subframe, based on the SCS, resulting in a variable slot duration of 1 ms, 0.5 ms, 0.25 ms, or 0.0125 ms for an SCS of 15 kHz, 30 kHz, 60 kHz, or 120 kHz, respectively). It is noted that the smallest unit of time for scheduling SL transmissions in NR V2X is a slot.

Multiple Active UL Configured Grants (CG) for Nr V2X Sidelink Uplink configured grants (UL CGs) may be composed of a set of periodic resources that may be used to schedule V2X transmissions semi-persistently. Rel-16 includes the support for multiple active UL CGs in order to support eV2X services with distinct requirements (e.g., latency, packet size, and reliability). These grants are also activated, configured, and released using the Downlink Control Information (DCI) such that a UE may have two active UL CGs. Each grant is characterized by a time-frequency domain allocation(s), the periodicity of the time-frequency domain allocation(s), and number of blind retransmissions of a TB (the number of blind retransmissions can be 2, 4, or 8). A characterization of Rel-16 UL CG is available in 3GPP TS 38.331, and it includes the modulation and coding scheme (MCS), TB size, demodulation reference signal (DM-RS) configuration, and an indication of whether power control should be utilized or not (See also TS 38.213).
Multiple CGs with Different Periodicities

Multiple active CGs configured at a device can support the different requirements associated with the data intended to use the periodic transmissions. For example, for every UL TB transmission, the device would select the active UL CG that most closely satisfies the service requirements, and it may occur that when a UE has multiple active UL CGs, there are resources assigned to the different grants that reference the same slot (e.g., they coincide in the time and frequency domains). In this case, the UE selects for this TB transmission the configuration (from the grants that overlap on the same slot) that best fits the service requirements. It should be noted that a UE can only perform one transmission using any of the UL CGs at a time (e.g., at the same slot) and that the smallest unit of time for scheduling SL transmissions in NR V2X is a slot.

In this disclosure, the use of the terms “overlap” and “contention” are related, but different. The term “overlap” may refer to a condition when different scheduling allocations indicate the reservation of the same transmission resources. The term “contention” refers to the intended use of a transmission resource by different processes.

As indicated in TR 38.211, a sidelink physical channel corresponds to a set of resource elements carrying information originating from higher layers. The following sidelink physical channels are defined therein: Physical Sidelink Shared Channel (PSSCH), Physical Sidelink Broadcast Channel (PSBCH), Physical Sidelink Control Channel (PSCCH), and Physical Sidelink Feedback Channel (PSFCH).

Additionally, a sidelink physical signal corresponds to a set of resource elements used by the physical layer but does not carry information originating from higher layers. The following sidelink physical signals are defined in TR 38.211: Demodulation Reference Signal (DM-RS), Channel-State Information Reference Signal (CSI-RS), Phase-Tracking Reference Signal (PT-RS), Sidelink Primary Synchronization Signal (S-PSS), and Sidelink Secondary Synchronization Signal (S-SSS).

As discussed above, enhancements to positioning techniques may be achieved by taking advantage of the wider bandwidths provided by NR via FR1 and FR2, such that Positioning Reference Signals (PRS) may be allocated to resources that are transmitted and/or received by both gNB and devices (e.g., terminal devices, such as UEs and/or V2X-type devices).

The 3GPP TSG Radio Access Network (RAN) WG1 (more commonly known as “RAN1”) may define a new positioning reference signal as an extension to the sidelink physical signals (section 8.1.2 of TR 28.211), which is based on the existing PRS and SRS formats. For the purposes of this disclosure, such new positioning reference signal is referred to as “SL-PRS”. As noted, the SL-PRS may use the existing PRS and SRS formats as a baseline; as such, two types of positioning signals may be defined for SL-PRS. For the purposes of this disclosure, such two types of positioning signals are referred to as Type-1_SL-PRS and Type-2_SL-PRS, which may be based on PRS and SRS, respectively. The type of SL-PRS supported by the device may be a device capability (e.g., Type-1_SL-PRS may be mandatory and Type-2_SL-PRS may be optional).

Accordingly, several embodiments of the process of selecting which reference signal (e.g., Type-1_SL-PRS or Type-2_SL-PRS) to transmit when both reference signals are scheduled for transmission using the same time and frequency domain resources are described in greater detail below.

Given that multiple active UL Configured Grants (CG) may be valid for a NR V2X sidelink type device, and that each active CG indicates a set of transmission resources (e.g., the time and frequency domain resources used to transport data as allocated to a CG by a gNB), and that the periodicity of the set of transmission resources indicated by a first CG may be different than the periodicity of the set of transmission resources defined in a second CG, there is a potential that a set of transmission resources indicated by the first CG may at some point in time, and from time to time thereafter, overlap partially or in whole with a set of transmission resources indicated by the second CG.

The device may receive from the gNB an RRCReconfiguration message that enables the device to use Type-1_SL-PRS, or Type-2_SL-PRS, or both Type-1_SL-PRS and Type-2_SL-PRS while the device is in coverage (e.g., SL MODE1).

Alternately, the device may receive from the gNB an RRCReconfiguration message that enables the device to use Type-1_SL-PRS, or Type-2_SL-PRS, or both Type1_SL-PRS and Type-2_SL-PRS while the device is out of coverage (e.g., SL MODE2).

Alternately, when the device is out of coverage (e.g., SL MODE2) and the device has not received an RRC configuration (or a System Information Block (SIB) message) indicating the type of SL-PRS to use, the device may determine to use either Type1_SL-PRS or Type-2_SL-PRS depending on a scan of neighbor devices for Type1_SL-PRS or Type-2_SL-PRS and using the same type as the neighbor, or the UE may determine to select either Type-1_SL-PRS or Type-2_SL-PRS when it initiates its own transmission if no neighbor devices are found to be using SL-PRS, or the UE may determine to select either Type-1_SL-PRS or Type-2_SL-PRS when it initiates its own transmission if no neighbor devices are found.

Further, the set of transmission resources indicated by a first CG may be used to transmit a first Transport Block, where the first Transport Block includes slots and symbols allocated to a first process, and the UE has determined to use Type-1_SL-PRS in such slots and symbols for SL-PRS transmission. Also, the set of transmission resources indicated by a second CG may be used to transmit a second Transport Block, where the second Transport Block includes slots and symbols allocated to a second process, and the device has determined to use Type-2_SL-PRS in such slots and symbols for SL-PRS transmission. Consequently, in such a situation, the Type1_SL-PRS and Type-2_SL-PRS of the first and second Transport Block, respectively, may be scheduled to use, in whole or in part, the same set of transmission resources.

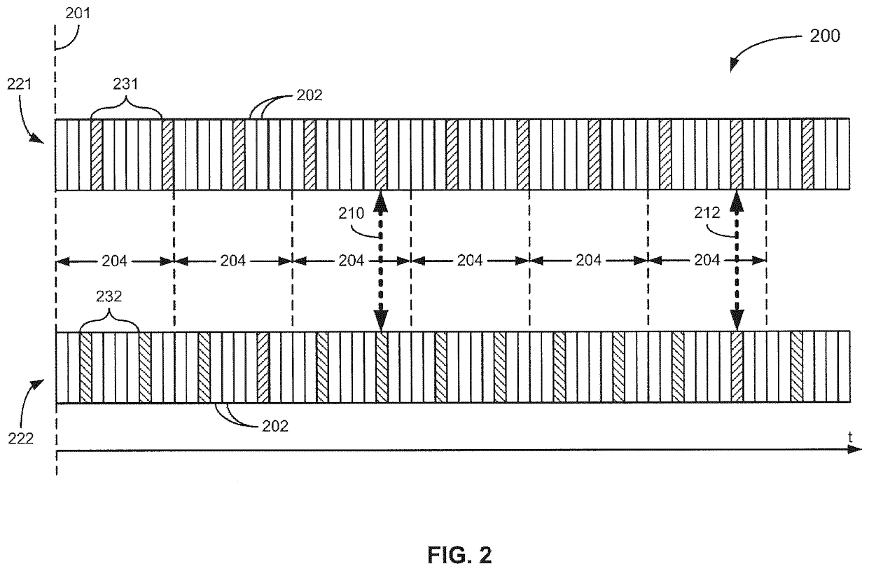

FIG. 2 is a timing diagram 200 illustrating transmission resources of two periodically overlapping Configured Grants (CGs) assigned to a device, according to an example implementation of the present disclosure. Timing diagram 200 indicates the relative positioning of representative subframes 204, as well as slots 202 within subframes 204. A first CG 221 that is assigned to the device indicates a set of transmission resources and an interval at which the set of transmission resources may re-occur (e.g., the periodicity of the set). Such a set may indicate that, starting from slot 0 of subframe 0 of radio frame 0 (denoted in FIG. 2 by a timing line 201), all symbols of the third slot of the zeroth subframe are to be used for a transmission of a Type-1_SL-PRS, and the set may re-occur at every sixth slot (indicated as a first periodicity 231 in FIG. 2) after the first occurrence (e.g., slots 9, 15, 21, 27, etc.), as denoted by right-leaning texture lines in FIG. 2.

Also, a second CG 222 that is assigned to the device indicates a set of transmission resources and an interval at which the set of transmission resources may re-occur (e.g., the periodicity of the set). Such a set may indicate that starting from slot 0 of subframe 0 of radio frame 0, all symbols of the second slot of the zeroth subframe are to be used for a transmission of a Type-2_SL-PRS, and the set may re-occur at every fifth slot (indicated as a second periodicity 232 in FIG. 2) after the first occurrence (e.g., slots 7, 12, 17, 22, 27, etc.), as denoted by left-leaning texture lines in FIG. 2.

Thus, in the example of FIG. 2, the set of transmission resources indicated by the first CG 221 and by the second CG 222 overlap on the occurrence of the 27^{th} slot (marked as slot 210 in FIG. 2). The overlap of the slot occurs for all symbols of the 27^{th} slot as assigned to the first CG 221 for the transmission of Type-1_SL-PRS and for all symbols of the 27^{th} slot as assigned to the second CG 222 for the transmission of Type-2_SL-PRS. The overlap results in a contention for the use of all symbols of the 27^{th} slot. For the given example, the overlap condition will periodically reoccur every 30^{th} slot (e.g., the 57^{th} slot, marked as slot 212 in FIG. 2) after the first overlap occurrence.

In this example, the first slots indicated for use by the set of transmission resources are slots 2 and 3. However, starting at slots 2 and 3 is a sufficient condition, but not a necessary condition, for the overlap, as the starting slots could be any slot, and the overlap condition will eventually occur.

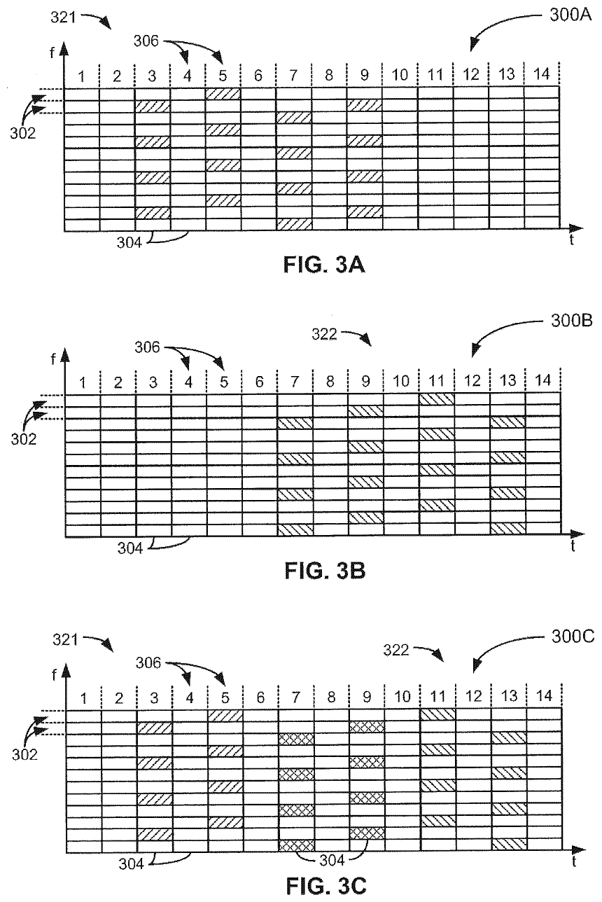

FIGS. 3A-3C are diagrams illustrating time-frequency resource grids 300A, 300B, and 300C of slots allocated by two periodically overlapping CGs assigned to a device, according to an example implementation of the present disclosure. In each diagram, the time domain is subdivided into fourteen symbols 306 of a slot (numbered from symbol 1 to symbol 14), and the frequency domain is subdivided into twelve frequency resources (subcarriers) 302, with each block representing a separate resource element, or transmission resource 304.

FIG. 3A depicts time-frequency resource grid 300A of a slot in which transmission resources are allocated by a first CG 321 that is assigned to the device. The first CG 321 indicates a set of transmission resources and an interval at which the set of transmission resources may re-occur (e.g., the periodicity of the set). Such a set may indicate that starting at slot 0 of subframe 0 of radio frame 0, symbols 3, 5, 7, and 9 of the ninth slot of the first subframe (as shown by right-leaning texture lines in FIG. 3A) are to be used for transmission of a Type-1_SL-PRS, and the set may re-occur at every seventh subframe after the first occurrence (e.g., 8, 15, 22, 29, 36, 43, etc.).

FIG. 3B depicts time-frequency resource grid 300B of a slot in which transmission resources are allocated by a second CG 322 that is assigned to the device. The second CG 322 indicates a set of transmission resources and an interval at which the set of transmission resources may re-occur (e.g., the periodicity of the set). Such a set may indicate that starting at slot 0 of subframe 0 of radio frame 0, symbols 7, 9, 11, and 13 of the ninth slot of the fourth subframe (as shown by left-leaning texture lines in FIG. 3B) are to be used for a transmission of a Type-2_SL-PRS, and the set may re-occur at every eighth subframe after the first occurrence (e.g., 12, 20, 28, 36, 44, etc.).

Thus, in this example, the set of transmission resources indicated by the first CG 321 and by the second CG 322 partially overlap on the occurrence of the ninth slot of the 36^{th} subframe. FIG. 3C depicts time-frequency resource grid 300C in which the sets of transmission resources indicated by the first CG 321 and by the second CG 322 partially overlap on the occurrence of the fourth slot of the 36^{th} subframe. The partial overlap of the slot occurs for symbols 7 and 9 of the slot (of symbol set 3, 5, 7, and 9) as assigned to the first CG 321 for the transmission of Type-1_SL-PRS, and the symbols 7 and 9 of the slot (of symbol set 7, 9, 11, and 13) as assigned to the second CG 322 for the transmission of Type-2_SL-PRS (as shown by cross-hatching in FIG. 3C). The overlap results in contention for the use of symbols 7 and 9 of the ninth slot of the 36^{th} subframe. For the given example, the overlap condition will periodically reoccur every 56^{th} subframe after the first overlap occurrence.

In this example, the first subframes indicated for use by the set of transmission resources are subframes 1 and 4. However, starting at subframes 1 and 4 is a sufficient condition, but not a necessary condition, for overlap, as the starting subframe could be any subframe, and the overlap condition will eventually occur.

As discussed above, a device may be configured with multiple active UL CGs (e.g., of Type-1 and Type-2 and of MODEL and MODE2). As such, the set of transmission resources indicated by the different UL CGs may, from time to time, reference the same slot and PRB of a sub-channel (e.g., the references indicate the same time and frequency allocation, and thus the references are in contention for the same transmission resources). The current specification does not describe procedures or processes by which a device may determine how to resolve the use of contested resources at the level of symbol per slot. Consequently, a need for exists additional specification to identify how a device may (1) be configured to select between either a Type-1_SL-PRS or Type-2_SL-PRS when a Type-1_SL-PRS and a Type-2_SL-PRS are scheduled to be transported over the contested resources of the Uu and/or PC5 interfaces, and (2) perform a selection between either a Type-1_SL-PRS or Type2_SL-PRS when a Type-1_SL-PRS and a Type-2_SL-PRS is scheduled to be transported over the contested resources of the Uu and/or PC5 interfaces.

It is noted that a sub-channel represents the smallest unit for a sidelink data transmission or reception, where a sub-channel includes a group of consecutive PRBs in a slot.

In this disclosure, the selection of SL-PRS may be considered to cover the usage of time and frequency domain resources as allocated for use by either Uu or PC5, or both. As such, when we discuss the “scheduling process” that determines the allocation of said time-frequency domain resources, in some implementations, such a scheduling process may be operating at a gNB, as in the case of scheduling resources for use by a device attached to the gNB via the Uu interface for the purpose of communication with the gNB. In some implementations, the scheduling process may be operating at a gNB, as in the case of scheduling resources for use by a first V2X-type device that is attached to the gNB (via the Uu interface), but the resources are from a resource pool configured at the first V2X type device for the purpose of communicating with another V2X-type device via the PC5 interface, as when operating under MODE1. Also, the scheduling process may be operating at a first V2X-type device, as in the case of scheduling resources for use by the first V2X-type device that is not attached to the gNB (via the Uu interface), and the resources are from a resource pool configured at the first V2X-type device for the purpose of communicating with another V2X-type device via the PC5 interface, as when operating under MODE2.

Described in greater below are an example signaling structure and signaling procedures that enable a device (e.g., a device operating as a UE, a V2X-type device, or both) to be configured with the necessary information for determining if a Type1_SL-PRS or a Type-2_SL-PRS is to be transported over the contested resources of the Uu and/or PC5 interfaces. Also described hereinafter are example parameters and logic that enables a device (e.g., a device operating as a UE, a V2X-type device, or both) to make a selection of transmitting either a Type-1_SL-PRS or a Type-2_SL-PRS over the contested resources of the Uu and/or PC5 interfaces.

In some implementations, a first CG may be assigned to the device, where the first CG indicates a set of transmission resources and the periodicity of the set for the periodic transmission, and an RRCReconfiguration message or SIB message may configure the use of Type-1_SL-PRS, where the RRCReconfiguration message may have priority over the SIB message. A second CG also may be assigned to the device, where the second CG indicates a set of transmission resources and the periodicity of the set for the periodic transmission, and an RRCReconfiguration message or SIB message may configure the use of Type-2_SL-PRS, where the RRCReconfiguration message may have priority over the SIB message. Consequently, the same set of transmission resources may be used at some point in time for their respective transmissions of SL-PRS. For example, at some point in time, contention may exist for the use of the set of transmission resources of the first CG and the second CG, where the contested transmission resources of the first CG are to transport a Type-1_SL-PRS, and the contested transmission resources of the second CG are to transport a Type2_SL-PRS.

In some implementations, a first resource pool may be assigned to the device, where the first resource pool indicates a set of transmission resources and the periodicity of the set for the periodic transmission, and an RRCReconfiguration message or SIB message may configure the use of Type-1_SL-PRS, where the RRCReconfiguration message may have priority over the SIB message. A second resource pool may be assigned to the device, where the second resource pool indicates a set of transmission resources and the periodicity of the set for the periodic transmission, and an RRCReconfiguration message, or an SIB message may configure the use of Type-2_SL-PRS, where the RRCReconfiguration message has priority over the SIB message. Consequently, the same set of transmission resources may be used at some point in time for their respective transmission of SL-PRS. For example, at some point in time, contention may exist for the use of the set of transmission resources of the first resource pool and of the second resource pool, where the contested transmission resources of the first resource pool are to transport a Type-1_SL-PRS, and the contested transmission resources of the second resource pool are to transport a Type2_SL-PRS.

In response to the foregoing scenarios, in some implementations, selection control (e.g., enabling and disabling of SL-PRS transmission), operational parameters (e.g., QoS values), and/or the logic (e.g., an algorithm operating in the device) associated with the selection control and the parameters may be specified. Such specification may ensure that the appropriate SL-PRS signal (either Type-1 or Type2) is transmitted by the device when the transmission resources that are pre-allocated to the device (via multiple active CGs or SL resource pools) overlap in the time and frequency domains.

To support a device with multiple processes that may require the transmission of periodic data, where the processes may or may not require different periodicities for the transmission of said data, a scheduling process may consider the allocation of transmission resources at the level of individual symbols of a slot, slots of a subframe, and the subframe associated with the symbols and slots. The goal of such scheduling may be to provide the processes of the device with transmission resource allocations that are distributed in the time domain in a non-overlapping manner.

Additionally, the scheduler may take into account the throughput (e.g., Quality of Service (QoS)) requirements of the processes associated with the periodic data and, therefore, the periodicity of a first allocation of transmission resources by the scheduler to a first process may be different than the periodicity of a second allocation of transmission resources by the scheduler for a process.

While the remainder of this disclosure focuses on two processes associated with different periodic transmissions, the various concepts disclosed herein are not so limited, as there may be three or more processes active on the device that require the use of periodic transmission resources for the transport of data.

Also, for the remainder of this disclosure, the term “transmission resource” may refer to the time resources and frequency resources used jointly to define the radio frequency (RF) waveforms that transport data. An example of a transmission resource may be at least one resource element.

In some implementations, the processes of a device that require transmission resources for the transport of data may request the scheduler for an allocation of transmission resources sufficient for the transport of several TBs. In the case that the scheduler is at the gNB (e.g., the request is for UL transmission on Uu or for MODE1 V2X transmission on PC5), the device may send a device assistance information message (e.g., UEAssistanceInformation) to the gNB that includes information about the expected traffic generated by the process of the device, such as the periodicity of TBs, the expected maximum size of the TBs, and the expected traffic's associated QoS requirements. In the case that the device is using MODE2 V2X transmission on PC5, the scheduler on the device may autonomously select the periodicity of TBs, TB maximum size, and the associated QoS requirements of the requesting process when selecting resources from the resource pool.

However, as discussed above, different allocations with different periodicities may, at some interval, overlap at the level of the symbol of a slot, and a slot of a subframe, thus causing contention between the allocations for the use of the same RF resources.

Also, as discussed above, the duration of a slot is related to the Subcarrier Spacing (SCS) configuration, as defined by the NR carrier configuration parameters for a specific OFDM numerology, where such a numerology describes the time and frequency domains of waveforms used by the Physical Resource Blocks (PRB) to transport data via the NR carrier. For example, if the SL BWP of a carrier bandwidth is configured with an SCS of 15 kHz, then the slot length is 1.0 ms and a symbol length of 66.67 μs, while a SL BWP of a carrier bandwidth that is configured with an SCS of 120 kHz will have a slot length of 0.125 ms and a symbol length of 8.33 μs.

A scheduling process tasked with the allocation of periodic resources in the time domain may also consider the availability of PRB resources across the SL BWP.

When a scheduler allocates to a device a periodic set of transmission resources via a CG, the scheduler may not have a priori knowledge whether the device will actually transmit data on the set of transmission resources made available for the device's use at each period of the allocation. This is because at the occurrence of each period of the allocation, the processes of a device may or may not have data to transmit (e.g., the transmit buffer of the device maybe be empty at a time when the next periodically scheduled set of transmission resources is available for the device's use).

For example, when a scheduler allocates to a device a first periodic set of transmission resources via a first CG, and the scheduler allocates to the device a second periodic set of transmission resources via a second CG, then at some interval that is common to both the first periodic allocation and the second periodic allocation, the set of transmission resources of the first periodic allocation may contend for the use of some or all of the symbols of the same slot as the set of transmission resources of the second periodic allocation.

However, one or both of the processes that are associated with different periodic allocations may not have data to transmit at the period of time of the contested symbols of the same slot, and thus there is no contention problem to be resolved at that time. Alternately, the processes associated with different allocations may both have data available for the device to transmit at the period of time of the contested symbols of the same slot, and thus a contention problem exists that may be resolved.

In the case that contention exists for the use of transmission resources of a first allocation and a second allocation for the transport of data, the device may determine if the contested transmission resources are the symbols of the same slot that would carry either Type-1_SL-PRS or Type-2_SL-PRS. Further, if contention is determined to be on symbols of the same slot that would carry either Type-1_SL-PRS or Type2_SL-PRS, the device may make a further determination as to whether the contested symbols of the same slot are to be used to transmit either the Type-1_SL-PRS or the Type-2_SL-PRS.

In some implementations, the determination on the use of contested symbols of the same slot for the transmission of either Type-1_SL-PRS or Type-2_SL-PRS may be the result of a “selection process” that is operating on the device. Where the operations of the selection process making the determination are configurable, the data used for the configuration of the selection process (referred to herein as “selection process configuration data”) may be generated in a number of ways. For example, the selection process configuration data may be generated at the time of the manufacturing of the device and provisioned into the device. In another example, the selection process configuration data may be generated by the NW (e.g., a base station of the NW) and sent to the device via an RRCReconfiguration message. In yet another example, the selection process configuration data may be generated by way of a hybrid operation in which the data used for configuration may have been initially provisioned into the device at the time of device manufacturing and then subsequently revised or updated, in whole or in part, with configuration data that has been generated by the NW and sent to the device via an RRCReconfiguration message.

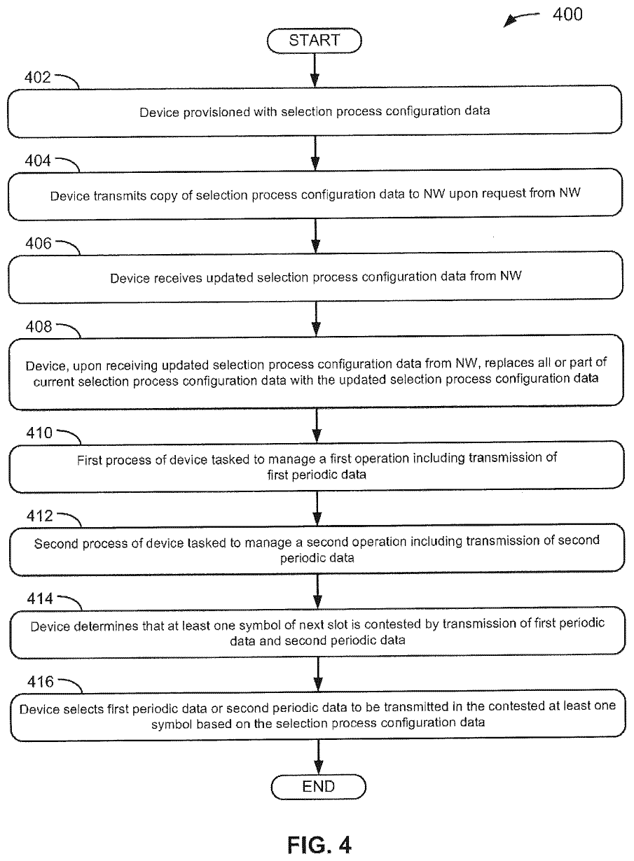

FIG. 4 is a flowchart illustrating a method (or process) 400 of configuring a device (e.g., a UE and/or a V2X-type device) and employing that configuration to perform a selection process, according to an example implementation of the present disclosure. In some implementations, the selection process may determine whether a first periodic data (e.g., a Type-1_SL-PRS) or a second periodic data (e.g., a Type-2_SL-PRS) is to be transmitted when at least one transmission resource (e.g., at least one symbol) is contested between the first and second periodic data. The method 400 may start at operation 402, wherein the device may be provisioned (e.g., at the time of manufacturing of the device) with selection process configuration data. At operation 404, the device may transmit a copy of the selection process configuration to the NW (e.g., upon request from the NW, such as by a gNB). At operation 406, the device may receive updated selection process configuration data from the NW. In some implementations, the NW may transmit to the device the selection process configuration data in an RRCReconfiguration message that carries one or more Information Elements (IEs) carrying the selection process configuration data (e.g., an otherConfig IE, which may include a SelectionProcessConfiguredData IE, as described in greater detail below). At operation 408, the device, upon receiving the updated selection process configuration data from the NW, may replace all or part of the current selection process configuration data with the updated selection process configuration data.

At operation 410, a first process initiated or operating in the device may be tasked to manage a first operation that includes transmission of the first periodic data (e.g., a Type-1_SL-PRS). Similarly, at operation 412, a second process initiated or operating in the device may be tasked to manage a second operation that includes transmission of the second periodic data (e.g., a Type-2_SL-PRS). In some implementations, the transmission of the first periodic data may use first transmission resources allocated by a first Configured Grant (CG), and the transmission of the second periodic data may second use transmission resources allocated by a second Configured Grant (CG).

At operation 414, the device may determine that at least one symbol of an upcoming slot (e.g., the next slot) is contested by transmission of the first periodic data and the second periodic data. Based on such determination, the device, at operation 416, may select the first periodic data or the second periodic data (e.g., using the selection process mentioned above) to be transmitted in the contested at least one symbol based on the selection process configuration data. Accordingly, the first or second periodic data that is not selected is not transmitted in the contested at least one symbol. In some implementations, once the selection process determines that the first periodic data (e.g., the Type-1_SL-PRS) or the second periodic data (e.g., the Type-2_SL-PRS) is to be transmitted in the contested resources of a slot n, the physical layer will transport the appropriate SL-PRS type in the contested slot n. The selection process may then continue in the next slot n+1 if there is a contention of resources in slot n+1.

In some implementations, the selection process may include several individual procedures. Each procedure may execute in sequence, and each procedure may determine an outcome of the selection of Type-1_SL-PRS and Type-2_SL-PRS if configured to do so. In some implementations, each subsequent procedure may override the outcome of a previous procedure.

In some implementations, the one or more procedures of the selection process may take into account some additional data that is used to direct the operation of the procedures, and such data may be configured on the device via signals sent to the device from a gNB, or such data may be configured on the device at the time of device manufacturing, or such data may be a hybrid of data from the gNB and data configured on the device at the time of device manufacturing.

In some implementations, the selection process configuration data may provide one or more of the following discrete directives, which may be used to enable and/or disable one or more procedures that contribute to the outcome of the selection process:
(1) Type-1_SL-PRS is nominally selected for transmission in the contested transmission resources.
(2) Type-2_SL-PRS is nominally selected for transmission in the contested transmission resources.
(3) Quality of Service (QoS) is used to nominally select transmission in the contested transmission resources. For example, a QoS associated with the Type-1_SL-PRS and a Type-1_SL-PRS QoS Threshold may be used to determine if Type-1_SL-PRS is nominally selected for transmission in the contested transmission resources. In another example, a QoS associated with the Type-2_SL-PRS and a Type-2_SL-PRS QoS Threshold may be used to determine if Type-2_SL-PRS is nominally selected for transmission in the contested transmission resources. In yet another example, a QoS associated with the Type-1_SL-PRS and a QoS associated with the Type-2_SL-PRS may be used to determine if Type-1_SL-PRS or Type-2_SL-PRS is nominally selected for transmission in the contested transmission resources.

In some implementations, the selection process configuration data may provide one or more of the following values that may be used to define operating parameters of the procedures that contribute to the outcome of the selection process:
(1) QoS Threshold for selecting Type-1_SL-PRS (as mentioned above).
(2) QoS Threshold for selecting Type-2_SL-PRS (as mentioned above).

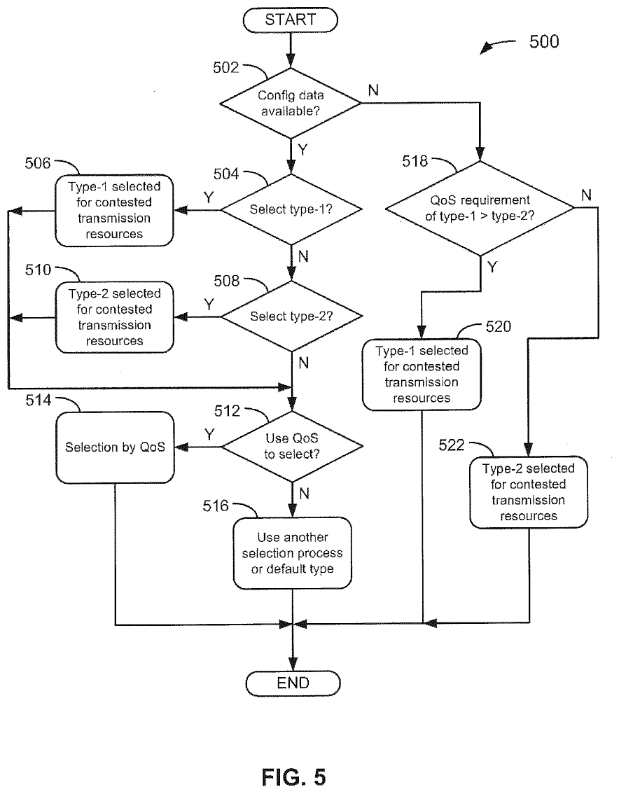

FIG. 5 is a flowchart illustrating a method 500 for a selection process for selecting between different periodic data transmissions, according to an example implementation of the present disclosure. In some implementations, the selection process may determine whether a first periodic data (e.g., a Type-1_SL-PRS) or a second periodic data (e.g., a Type-2_SL-PRS) is to be transmitted when at least one transmission resource is contested between the first and second periodic data. The method 500 starts at operation 502, in which the device (e.g., a UE and/or a V2X-type device) determines whether selection process configuration data (e.g., as described above) is available. In some implementations, the device performing method 500 may have been provisioned with configuration data during the manufacturing of the device, received from the NW, or some combination thereof, as discussed above in conjunction with method 400 of FIG. 4.

If the configuration data is not available, the device, at operation 518, may determine whether a Quality of Service (QoS) associated with the first periodic data is greater than a QoS associated with the second periodic data. If the QoS (e.g., an expected or required QoS) associated with the first periodic data is greater than the QoS associated with the second periodic data, the device, at operation 520, may select the first periodic data for transmission in the contested transmission resources. Otherwise, the device, at operation 522, may select the second periodic data for transmission in the contested transmission resources.

Returning to operation 502, if the device determines that the selection process configuration data is available, the device, at operation 504, may determine whether the configuration data indicates that the first periodic data is to be selected over the second periodic data. If so, the device, at operation 506, may select the first periodic data for transmission in the contested transmission resources. Otherwise, if the configuration data does not indicate that the first periodic data is to be selected over the second periodic data, the device, at operation 508, may determine whether the configuration data indicates that the second periodic data is to be selected over the first periodic data. If so, the device, at operation 510, may select the second periodic data for transmission in the contested transmission resources.

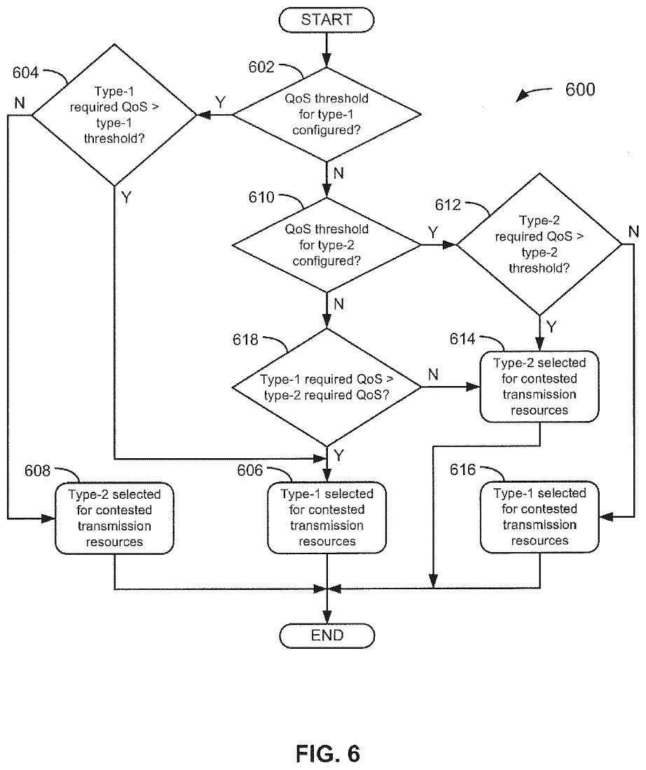

If, instead, the configuration data does not indicate that the second periodic data is to be selected over the first periodic data, the device, at operation 512, may determine whether the configuration data indicates that the selection between the first and second periodic data is to be based on the QoS associated with the first periodic data and the second periodic data. If so, the device, at operation 514, may perform the selection procedure based on the QoS associated with the first and second periodic data (e.g., as described below in conjunction with the method illustrated in FIG. 6). Otherwise, if the configuration data does not indicate that the selection between the first and second periodic data is to be based on the QoS of the first and second processes, the device, at operation 516, may perform another selection process or procedure, or may select between the first and second periodic data based on a default selection value not associated with selection process configuration data.

FIG. 6 is a flowchart illustrating a method 600 for a QoS-based selection process for selecting between different periodic data transmissions, according to an example implementation of the present disclosure. In some implementations, the selection process may determine whether a first periodic data (e.g., a Type-1_SL-PRS) or a second periodic data (e.g., a Type-2_SL-PRS) is to be transmitted when at least one transmission resource is contested between the first and second periodic data. In some implementations, the method 600 may serve to perform the procedure of operation 514 of the method 500 of the selection process described above in connection with FIG. 5.

The method 600 starts at operation 602, in which the device (e.g., a UE and/or a V2X-type device) determines whether a first QoS threshold associated with the first periodic data is configured in the selection process configuration data. If so, the device, at operation 604, may determine whether a (required or expected) QoS associated with the first periodic data is greater than the QoS threshold of the first periodic data. If the QoS associated with the first periodic data is greater than the QoS threshold of the first periodic data, the device, at operation 606, may select the first periodic data for transmission in the contested transmission resources. If, instead, the QoS associated with the first periodic data is not greater than the QoS threshold of the first periodic data, the device, at operation 608, may select the second periodic data for transmission in the contested transmission resources.

Returning to operation 602, if a QoS threshold of the associated with the first periodic data is not configured in the selection process configuration data, the device, at operation 610, may determine whether a QoS threshold associated with the second periodic data is configured in the selection process configuration data. If so, the device, at operation 612, may determine whether a (required or expected) QoS associated with the second periodic data is greater than the QoS threshold of the second periodic data. If the QoS associated with the second periodic data is greater than the QoS threshold of the second periodic data, the device, at operation 614, may select the second periodic data for transmission in the contested transmission resources. If, instead, the QoS associated with the second periodic data is not greater than the QoS threshold of the second periodic data, the device, at operation 616, may select the first periodic data for transmission in the contested transmission resources.

Returning to operation 610, if a QoS threshold of the second periodic data is not configured in the selection process configuration data, the device, at operation 618, may determine whether the required or expected QoS associated with the first periodic data is greater than the required or expected QoS associated with the second periodic data. If the QoS associated with the first periodic data is greater than the QoS associated with the second periodic data, the device, at operation 606, may select the first periodic data for transmission in the contested transmission resources. Otherwise, if the QoS associated with the first periodic data is not greater than the QoS associated with the second periodic data, the device, at operation 614, may select the second periodic data for transmission in the contested transmission resources.

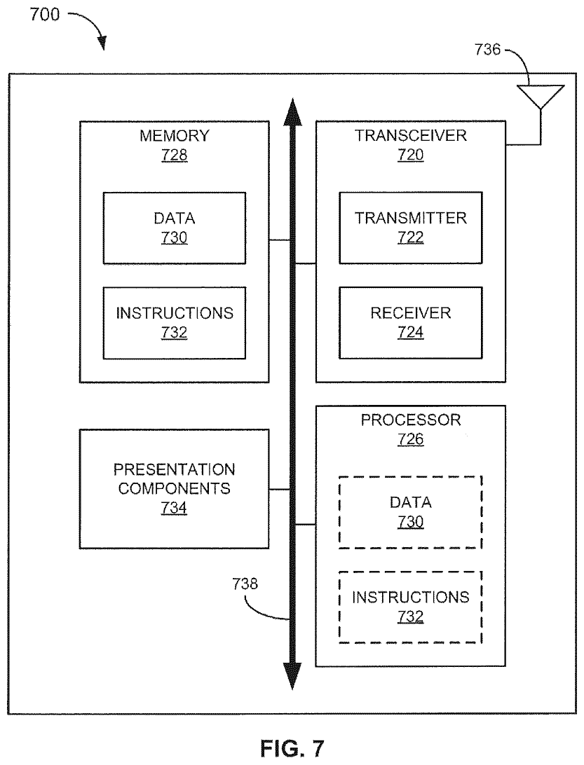

FIG. 7 illustrates a block diagram of a node for wireless communication, according to one example implementation of the present application. As shown in FIG. 7, node 700 may include transceiver 720, processor 726, memory 728, one or more presentation components 734, and at least one antenna 736. Node 700 may also include a Radio Frequency (RF) spectrum band module, a base station communications module, a network communications module, and a system communications management module, input/output (I/O) ports, I/O components, and power supply (not explicitly shown in FIG. 7). Each of these components may be in communication with each other, directly or indirectly, over one or more buses 740.

Transceiver 720 having transmitter 722 and receiver 724 may be configured to transmit and/or receive time and/or frequency resource partitioning information. In some implementations, transceiver 720 may be configured to transmit in different types of subframes and slots including, but not limited to, usable, non-usable and flexibly usable subframes and slot formats. Transceiver 720 may be configured to receive data and control signaling.

Node 700 may include a variety of computer-readable media. Computer-readable media can be any available media that can be accessed by node 700 and include both volatile and non-volatile media, removable and non-removable media. By way of example, and not limitation, computer-readable media may comprise computer storage media and communication media. Computer storage media include both volatile and non-volatile, removable and non-removable media implemented in any method or technology for storage of information such as computer-readable instructions, data structures, program modules or other data.

Computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media do not comprise a propagated data signal. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer-readable media.

Memory 728 may include computer-storage media in the form of volatile and/or nonvolatile memory. Memory 728 may be removable, non-removable, or a combination thereof. Exemplary memory includes solid-state memory, hard drives, optical-disc drives, etc. As illustrated in FIG. 7, memory 728 may store computer-readable, computer-executable instructions 732 (e.g., software codes) that are configured to, when executed, cause processor 726 to perform various functions described herein, for example, with reference to FIGS. 1 through 7. Alternatively, instructions 732 may not be directly executable by processor 726 but be configured to cause node 700 (e.g., when compiled and executed) to perform various functions described herein.

Processor 726 may include an intelligent hardware device, for example, a central processing unit (CPU), a microcontroller, an ASIC, etc. Processor 726 may include memory. Processor 726 may process data 730 and instructions 732 received from memory 728, and information through transceiver 720, the base band communications module, and/or the network communications module. Processor 726 may also process information to be sent to transceiver 720 for transmission through antenna 736, to the network communications module for transmission to a core network.

One or more presentation components 734 presents data indications to a person or other device. For example, one or more presentation components 734 include a display device, speaker, printing component, vibrating component, etc.

From the above description, it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

An example of an otherConfig IE that carries an IE (e.g., a SelectionProcessConfiguredData IE) that may include selection process configuration data (emphasized in bold below) for selecting between first periodic data (e.g., Type-1_SL-PRS) and second periodic data (e.g., Type-2_SL-PRS) that may be configured with contesting or conflicting transmission resources (e.g., as allocated via associated CGs), along with associated field descriptions, are illustrated in Table 2 below.

TABLE 2
OtherConfig IE

-- ASN1START
-- TAG-OTHERCONFIG-START

| | |
|---|---|
| OtherConfig ::= | SEQUENCE { |
| delayBudgetReportingConfig | CHOICE{ |
| release | NULL, |
| setup | SEQUENCE{ |

```
      delayBudgetReportingProhibitTimer ENUMERATED {s0, s0dot4, s0dot8, s1dot6,
s3, s6, s12, s30}
    }
  }
OPTIONAL -- Need M
}
```

| | |
|---|---|
| OtherConfig-v1540 ::= | SEQUENCE { |
| overheatingAssistanceConfig | SetupRelease {OverheatingAssistanceConfig} |

OPTIONAL, -- Need M
...
}
CandidateServingFreqListNR-r16 ::= SEQUENCE (SIZE (1..maxFreqIDC-r16)) OF ARFCN-ValueNR

| | |
|---|---|
| OtherConfig-v1610 ::= | SEQUENCE { |
| idc-AssistanceConfig-r16 | SetupRelease {IDC-AssistanceConfig-r16} |

OPTIONAL, -- Need M

| | |
|---|---|
| drx-PreferenceConfig-r16 | SetupRelease {DRX-PreferenceConfig-r16} |

OPTIONAL, -- Need M

| | |
|---|---|
| maxBW-PreferenceConfig-r16 | SetupRelease {MaxBW-PreferenceConfig-r16} |

OPTIONAL, -- Need M

| | |
|---|---|
| maxCC-PreferenceConfig-r16 | SetupRelease {MaxCC-PreferenceConfig-r16} |

OPTIONAL, -- Need M

| | |
|---|---|
| maxMIMO-LayerPreferenceConfig-r16 | SetupRelease |
| {MaxMIMO-LayerPreferenceConfig-r16} | OPTIONAL, -- Need M |
| minSchedulingOffsetPreferenceConfig-r16 | SetupRelease |
| {MinSchedulingOffsetPreferenceConfig-r16} | OPTIONAL, -- Need M |
| releasePreferenceConfig-r16 | SetupRelease {ReleasePreferenceConfig-r16} |

OPTIONAL, -- Need M

| | |
|---|---|
| referenceTimePreferenceReporting-r16 | ENUMERATED {true} |

OPTIONAL, -- Need R

| | |
|---|---|
| btNameList-r16 | SetupRelease {BT-NameList-r16} |

OPTIONAL, -- Need M

| | |
|---|---|
| wlanNameList-r16 | SetupRelease {WLAN-NameList-r16} |

OPTIONAL, -- Need M

| | |
|---|---|
| sensorNameList-r16 | SetupRelease {Sensor-NameList-r16} |

OPTIONAL, -- Need M

| | |
|---|---|
| obtainCommonLocation-r16 | ENUMERATED {true} |

OPTIONAL, -- Need R

| | |
|---|---|
| sl-AssistanceConfigNR-r16 | ENUMERATED{true} |

OPTIONAL -- Need R
}

| | |
|---|---|
| OtherConfig-v1700 ::= | SEQUENCE { |
| ul-GapFR2-PreferenceConfig-r17 | ENUMERATED {true} |

OPTIONAL, -- Need R

| | |
|---|---|
| musim-GapAssistanceConfig-r17 | SetupRelease |
| {MUSIM-GapAssistanceConfig-r17} | OPTIONAL, -- Need M |
| musim-LeaveAssistanceConfig-r17 | SetupRelease |
| {MUSIM-LeaveAssistanceConfig-r17} | OPTIONAL, -- Need M |
| successHO-Config-r17 | SetupRelease {SuccessHO-Config-r17} |

OPTIONAL, -- Need M

| | |
|---|---|
| maxBW-PreferenceConfigFR2-2-r17 | ENUMERATED {true} |

OPTIONAL, -- Cond maxBW

| | |
|---|---|
| maxMIMO-LayerPreferenceConfigFR2-2-r17 | ENUMERATED {true} |

OPTIONAL, -- Cond maxMIMO

| | |
|---|---|
| minSchedulingOffsetPreferenceConfigExt-r17 | ENUMERATED {true} |

OPTIONAL, -- Cond minOffset

| | |
|---|---|
| rlm-RelaxationReportingConfig-r17 | SetupRelease |
| {RLM-RelaxationReportingConfig-r17} | OPTIONAL, -- Need M |
| bfd-RelaxationReportingConfig-r17 | SetupRelease |
| {BFD-RelaxationReportingConfig-r17} | OPTIONAL, -- Need M |
| scg-DeactivationPreferenceConfig-r17 | SetupRelease |
| {SCG-DeactivationPreferenceConfig-r17} | OPTIONAL, -- Need M |
| rrm-MeasRelaxationReportingConfig-r17 | SetupRelease |
| {RRM-MeasRelaxationReportingConfig-r17} | OPTIONAL -- Need M |

}

| | |
|---|---|
| OtherConfig-v1800 ::= | SEQUENCE { |
| selectionProcessConfiguredData-r18 | SetupRelease |
| {SelectionProcessConfigurationData-r18} | OPTIONAL, -- Need M |

...
}

| | |
|---|---|
| SelectionProcessConfigurationData-r18 ::= | SEQUENCE { |
| thresholdQosType-1_SL-PRS-r18 | INTEGER (0..255) |

OPTIONAL, -- Need R

| | |
|---|---|
| thresholdQosType-2_SL-PRS-r18 | INTEGER (0..255) |

OPTIONAL, -- Need R

| | |
|---|---|
| selectType-1_SL-PRS-r18 | ENUMERATED {true} |

OPTIONAL, -- Need R

| | |
|---|---|
| selectType-2_SL-PRS-r18 | ENUMERATED {true} |

OPTIONAL, -- Need R

| | |
|---|---|
| useQosToSelect-r18 | ENUMERATED {true} |

OPTIONAL, -- Need R
}
......Note: remaining text removed for brevity......
}
-- TAG-OTHERCONFIG-STOP
-- ASN1STOP

Field Descriptions:
candidateServingFreqListNR
This field indicates, for each candidate NR serving cell, the center frequency around which UE is requested to report
IDC issues.
selectionProcessConfiguredData
This field configures the UE with parameters and directives related to the selection process.
thresholdQosType-1_SL-PRS-r18
A value compared to the QoS of the process that is requesting the Type-1_SL-PRS be transmitted, above which the
Type-1_SL-PRS is selected over Type-2_SL-PRS.
thresholdQosType-2_SL-PRS-r18
A value compared to the QoS of the process that is requesting the Type-2_SL-PRS be transmitted, above which the
Type-2_SL-PRS is selected over Type-1_SL-PRS.
select Type-1_SL-PRS -r18
An enumeration of TRUE indicates that the selection process will always select Type-1_SL-PRS over
Type-2_SL-PRS to resolve contention.
selectType-2_SL-PRS-r18
An enumeration of TRUE indicates that the selection process will always select Type-2_SL-PRS over
Type-1_SL-PRS to resolve contention.
useQosToSelect-r18
An enumeration of TRUE indicates that the selection process will always use QoS of Type-1_SL-PRS and
Type-2_SL-PRS to resolve contention.

An example of an RRCReconfiguration message that carries an IE (e.g., a SelectionProcessConfiguredData IE, by way of an otherConfig IE) that may include selection process configuration data (emphasized in bold below) for selecting between first periodic data (e.g., Type-1_SL-PRS) and second periodic data (e.g., Type-2_SL-PRS) is illustrated in Table 3 below.

TABLE 3
RRCReconfiguration IE

-- ASNISTART
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING CellGroupConfig) |

OPTIONAL, -- Cond SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs ::= | SEQUENCE { |
| masterCellGroup | OCTET STRING (CONTAINING CellGroupConfig) |

OPTIONAL, -- Need M

| | |
|---|---|
| fullConfig | ENUMERATED {true} |

OPTIONAL, -- Cond

| | |
|---|---|
| dedicatedNAS-MessageList | SEQUENCE (SIZE(1..maxDRB)) OF |
| DedicatedNAS-Message | OPTIONAL, -- Cond |
| masterKeyUpdate | MasterKeyUpdate |

OPTIONAL, -- Cond

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING SystemInformation) |

OPTIONAL, -- Need N

| | |
|---|---|
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| | |
|---|---|
| RRCReconfiguration-v1560-IEs ::= | SEQUENCE { |
| mrdc-SecondaryCellGroupConfig | SetupRelease |
| { MRDC-SecondaryCellGroupConfig } | OPTIONAL, -- Need M |
| radioBearerConfig2 | OCTET STRING (CONTAINING |
| RadioBearerConfig) | OPTIONAL -- Need M |
| sk-Counter | SK-Counter |

OPTIONAL, -- Need N

| | |
|---|---|
| nonCriticalExtension | RRCReconfiguration-v1610-IEs |

OPTIONAL
}

| | |
|---|---|
| RRCReconfiguration-v1610-IEs ::= | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 } |

OPTIONAL, -- Need M

| | |
|---|---|
| dedicatedPosSysInfoDelivery-r16 | OCTET STRING (CONTAINING |
| PosSystemInformation-r16-IEs) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease |
| {SL-ConfigDedicatedEUTRA-Info-r16} | OPTIONAL, -- Need M |
| targetCellSMTC-SCG-r16 | SSB-MTC |

OPTIONAL, -- Need S

| | |
|---|---|
| nonCriticalExtension | RRCReconfiguration-v1700-IEs |

OPTIONAL
}

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| sl-L2RelayUEConfig-r17 | SetupRelease { SL-L2RelayUEConfig-r17 } |

OPTIONAL, -- Cond L2RelayUE

| | |
|---|---|
| sl-L2RemoteUEConfig-r17 | SetupRelease { SL-L2RemoteUEConfig-r17 } |

OPTIONAL, -- Cond L2RemoteUE

| | |
|---|---|
| dedicatedPagingDelivery-r17 | OCTET STRING (CONTAINING Paging) |

OPTIONAL, -- L2U2NRelay

| | |
|---|---|
| needForNCSG-ConfigNR-r17 | SetupRelease {NeedForNCSG-ConfigNR-r17} |

OPTIONAL, -- Need M

| | |
|---|---|
| needForNCSG-ConfigEUTRA-r17 | SetupRelease {NeedForNCSG-ConfigEUTRA-r17} |

OPTIONAL, -- Need M

| | |
|---|---|
| musim-GapConfig-r17 | SetupRelease {MUSIM-GapConfig-r17} |

OPTIONAL, -- Need M

| | |
|---|---|
| scg-State-r17 | ENUMERATED { deactivated } |

OPTIONAL, -- Need S

| | |
|---|---|
| appLayerMeasConfig-r17 | AppLayerMeasConfig-r17 |

OPTIONAL, -- Need M

| | |
|---|---|
| nonCriticalExtension | RRCReconfiguration-v1800-IEs |

OPTIONAL
}

| | |
|---|---|
| RRCReconfiguration-v1800-IEs ::= | SEQUENCE { |
| otherConfig-v1800 | OtherConfig-v1800 |

OPTIONAL, -- Need N

| | |
|---|---|
| nr-type-1_SL-PRS-PDC-Info-r18 | SetupRelease |
| {NR-Type-1_SL-PRS-PDC-Info-r18} | OPTIONAL, -- Need M |
| nr-type-2_SL-PRS-PDC-Info-r18 | SetupRelease |
| {NR-Type-2_SL-PRS-PDC-Info-r18} | OPTIONAL, -- Need M |
| nonCriticalExtension | SEQUENC { } |

OPTIONAL
}
......Note: remaining text removed for brevity......
-- TAG-RRCRECONFIGURATION-STOP
-- ASN1STOP

Table 4 below illustrates the NT-Type-1_SL-PRS-PDC-Info IE shown in Table 3, which may indicate whether the device may generate a Type-1_SL-PRS for Propagation Delay Compensation (PDC), along with a field description.

TABLE 4
NR-Type-1_SL-PRS-PDC-Info IE

-- ASN1START
-- TAG- NR-Type-1_SL-PRS-PDC-Info-START

| | |
|---|---|
| NR-Type-1_SL-PRS-PDC-Info-r18 ::= | SEQUENCE { |
| type-1_SL-PRS-PDC-Info-r18 | ENUMERATED{true} |

OPTIONAL, -- Need N

| | |
|---|---|
| nr-DL-PRS-PDC-ResourceSet-r18 | NR-DL-PRS-PDC-ResourceSet-r17 |

OPTIONAL, -- Need R
...
}
-- TAG- NR-Type-1_SL-PRS-PDC-Info-STOP
-- ASN1STOP
Field Description:
type-1_SL-PRS-PDC-Info-r18
This field indicates that the physical layer can generate a Type-1_SL-PRS. For example, a modified pseudo-random
sequence that is modulated by Quadrature Phase Shift Keying (QPSK), where the pseudo-random sequence used is
a Gold sequence of length 31.

Table 5 below illustrates the NT-Type-2_SL-PRS-PDC-Info IE shown in Table 3, which may indicate whether the device may generate a Type-2_SL-PRS for PDC, along with a field description.

TABLE 5
NR-Type-2_SL-PRS-PDC-Info IE

-- ASN1START
-- TAG- NR-Type-2_SL-PRS-PDC-Info-START

| | |
|---|---|
| NR-Type-2_SL-PRS-PDC-Info-r18 ::= | SEQUENCE { |
| type-2_SL-PRS-PDC-Info-r18 | ENUMERATED{true} |

OPTIONAL, -- Need N

| | |
|---|---|
| nr-DL-PRS-PDC-ResourceSet-r18 | NR-DL-PRS-PDC-ResourceSet-r17 |

OPTIONAL, -- Need R
...
}
-- TAG- NR-Type-2_SL-PRS-PDC-Info-STOP
-- ASN1STOP
Field Description:
type-2_SL-PRS-PDC-Info-r18
This field indicates that the physical layer can generate a Type-2_SL-PRS. For example, a modified reference signal
(based on NR-SRS) sent by the UE is an OFDM-modulated Zadoff-Chu sequency.

Table 6 below illustrates a SL-DL-PRS-PDC-Info IE associated with the nr-DL-PRS-PDC-ResourceSet-r18 field shown in Tables 4 and 5, which defines a downlink PRS configuration for PDC (e.g., periodicity of the PRS, slot offset of the resource set allocated to the PRS, etc.).

TABLE 6
NR-DL-PRS-PDC-Info IE

-- ASN1START
-- TAG-NR-DL-PRS-PDC-INFO-START

| | |
|---|---|
| NR-DL-PRS-PDC-Info-r18 ::= | SEQUENCE { |
| nr-DL-PRS-PDC-ResourceSet-r18 | NR-DL-PRS-PDC-ResourceSet-r17 |

OPTIONAL, -- Need R
...
}

| | |
|---|---|
| NR-DL-PRS-PDC-ResourceSet-r17 ::= | SEQUENCE { |
| periodicityAndOffset-r17 | NR-DL-PRS-Periodicity-and-ResourceSetSlotOffset-r17, |
| numSymbols-r17 | ENUMERATED {n2, n4, n6, n12, spare4, spare3, spare2, |

spare1},

| | |
|---|---|
| dl-PRS-ResourceBandwidth-r17 | INTEGER (1..63), |
| dl-PRS-StartPRB-r17 | INTEGER (0..2176), |
| resourceList-r17 | SEQUENCE (SIZE (1..maxNrofPRS-ResourcesPerSet-r17)) OF |

NR-DL-PRS-Resource-r17,

| | |
|---|---|
| repetitionFactor-r17 | ENUMERATED {n2, n4, n6, n8, n16, n32, spare2, spare1} |

OPTIONAL, -- Need S

| | |
|---|---|
| timeGap-r17 | ENUMERATED {s1, s2, s4, s8, s16, s32, spare2, spare1} |

```
OPTIONAL, -- Need S
  ...
}
NR-DL-PRS-Periodicity-and-ResourceSetSlotOffset-r17 ::= CHOICE {
  scs15-r17 CHOICE {
```

| | |
|---|---|
| n4-r17 | INTEGER (0..3), |
| n5-r17 | INTEGER (0..4), |
| n8-r17 | INTEGER (0..7), |
| n10-r17 | INTEGER (0..9), |
| n16-r17 | INTEGER (0..15), |
| n20-r17 | INTEGER (0..19), |
| n32-r17 | INTEGER (0..31), |
| n40-r17 | INTEGER (0..39), |
| n64-r17 | INTEGER (0..63), |
| n80-r17 | INTEGER (0..79), |
| n160-r17 | INTEGER (0..159), |
| n320-r17 | INTEGER (0..319), |
| n640-r17 | INTEGER (0..639), |
| n1280-r17 | INTEGER (0..1279), |
| n2560-r17 | INTEGER (0..2559), |
| n5120-r17 | INTEGER (0..5119), |
| n10240-r17 | INTEGER (0..10239), |

```
        ...
  },
  scs30-r17 CHOICE {
```

| | |
|---|---|
| n8-r17 | INTEGER (0..7), |
| n10-r17 | INTEGER (0..9), |
| n16-r17 | INTEGER (0..15), |
| n20-r17 | INTEGER (0..19), |
| n32-r17 | INTEGER (0..31), |
| n40-r17 | INTEGER (0..39), |
| n64-r17 | INTEGER (0..63), |
| n80-r17 | INTEGER (0..79), |
| n128-r17 | INTEGER (0..127), |
| n160-r17 | INTEGER (0..159), |
| n320-r17 | INTEGER (0..319), |
| n640-r17 | INTEGER (0..639), |
| n1280-r17 | INTEGER (0..1279), |
| n2560-r17 | INTEGER (0..2559), |
| n5120-r17 | INTEGER (0..5119), |
| n10240-r17 | INTEGER (0..10239), |
| n20480-r17 | INTEGER (0..20479), |

```
        ...
  },
  scs60-r17 CHOICE {
```

| | |
|---|---|
| n16-r17 | INTEGER (0..15), |
| n20-r17 | INTEGER (0..19), |
| n32-r17 | INTEGER (0..31), |
| n40-r17 | INTEGER (0..39), |
| n64-r17 | INTEGER (0..63), |
| n80-r17 | INTEGER (0..79), |
| n128-r17 | INTEGER (0..127), |
| n160-r17 | INTEGER (0..159), |
| n256-r17 | INTEGER (0..255), |
| n320-r17 | INTEGER (0..319), |
| n640-r17 | INTEGER (0..639), |
| n1280-r17 | INTEGER (0..1279), |
| n2560-r17 | INTEGER (0..2559), |
| n5120-r17 | INTEGER (0..5119), |
| n10240-r17 | INTEGER (0..10239), |
| n20480-r17 | INTEGER (0..20479), |
| n40960-r17 | INTEGER (0..40959), |

```
        ...
  },
  scs120-r17 CHOICE {
```

| | |
|---|---|
| n32-117 | INTEGER (0..31), |
| n40-r17 | INTEGER (0..39), |
| n64-r17 | INTEGER (0..63), |
| n80-r17 | INTEGER (0..79), |
| n128-r17 | INTEGER (0..127), |
| n160-r17 | INTEGER (0..159), |
| n256-17 | INTEGER (0..255), |
| n320-r17 | INTEGER (0..319), |
| n512-r17 | INTEGER (0..511), |
| n640-r17 | INTEGER (0..639), |
| n1280-r17 | INTEGER (0..1279), |
| n2560-r17 | INTEGER (0..2559), |
| n5120-r17 | INTEGER (0..5119), |
| n10240-r17 | INTEGER (0..10239), |
| n20480-r17 | INTEGER (0..20479), |
| n40960-r17 | INTEGER (0..40959), |
| n81920-r17 | INTEGER (0..81919), |

```
        ...
  },
  ...
}
NR-DL-PRS-Resource-r17 ::= SEQUENCE {
```

| | |
|---|---|
| nr-DL-PRS-ResourceID-r17 | NR-DL-PRS-ResourceID-r17, |
| dl-PRS-SequenceID-r17 | INTEGER (0..4095), |
| dl-PRS-CombSizeN-AndReOffset-r17 | CHOICE { |
| n2-r17 | INTEGER (0..1), |
| n4-r17 | INTEGER (0..3), |
| n6-r17 | INTEGER (0..5), |
| n12-r17 | INTEGER (0..11), |

```
      ...
  },
```

| | |
|---|---|
| dl-PRS-ResourceSlotOffset-r17 | INTEGER |

(0..maxNrofPRS-ResourceOffsetValue-1-r17),

| | |
|---|---|
| dl-PRS-ResourceSymbolOffset-r17 | INTEGER (0..12), |
| dl-PRS-QCL-Info-r17 | DL-PRS-QCL-Info-r17 |

OPTIONAL, -- Need N
...
}
DL-PRS-QCL-Info-r17 ::= CHOICE {

| | |
|---|---|
| ssb-r17 | SEQUENCE { |
| pci-r17 | PhysCellId, |
| ssb-Index-r17 | INTEGER (0..63), |
| rs-Type-r17 | ENUMERATED {typeC, typeD, typeC-plus-typeD} |

},

| | |
|---|---|
| dl-PRS-r17 | SEQUENCE { |
| qcl-DL-PRS-ResourceID-r17 | NR-DL-PRS-ResourceID-r17, |

```
    ...
  },
  ...
}
NR-DL-PRS-ResourceID-r17 ::= INTEGER (0..maxNrofPRS-ResourcesPerSet-1-r17)
-- TAG-NR-DL-PRS-PDC-INFO-STOP
-- ASN1STOP
```

The following Table 7 illustrates an example of what the NR UE may do upon reception of a RRCReconfiguration message with an otherConfig IE that includes a selectionProcessConfiguredData IE, as an addition to the existing text in TS 38.331, at Sections 5.3.5.3 and 5.3.5.9 therein, related to a conditional configuration (e.g., a conditional handover (CHO) or a Conditional PSCell Change (CPC)). Pertinent portions of Table 7 are presented in bold.

TABLE 7
5.3.5.3 Upon receiving of the RRCReconfiguration, or upon execution of the conditional
configuration (CHO or CPC):

| 1> | if the RRCReconfiguration is applied due to a conditional reconfiguration execution upon cell selection | |
|---|---|---|
| | performed while timer T311 was running, as defined in 5.3.7.3: | |
| | 2> | remove all the entries within VarConditionalReconfig, if any; |

.... Text removed for brevity....

| 1> | if the RRCReconfiguration message includes the otherConfig: | |
|---|---|---|
| | 2> | perform the other configuration procedure as specified in 5.3.5.9; |

..... Remaining text of 5.3.5.3 removed for brevity....
5.3.5.9 Other configuration
The UE shall:

| 1> | if the received otherConfig includes the delayBudgetReportingConfig: | |
|---|---|---|
| | 2> | if delayBudgetReportingConfig is set to setup: |

| | |
|---|---|
| 3> | consider itself to be configured to send delay budget reports in accordance with 5.7.4; |

| | |
|---|---|
| 2> | else: |

| | |
|---|---|
| 3> | consider itself not to be configured to send delay budget reports and stop timer T342, if running. |

| 1> | if the received otherConfig includes the selectionProcessConfiguredData: | |
|---|---|---|
| | 2> | if selectionProcessConfiguredData is set to setup |

| | |
|---|---|
| 3> | consider itself to be configured to execute the type-1_SL-PRS and type-2_SL-PRS Selection |
| | Process. |
| 3> | forward the data of selectionProcessConfiguredData to the Selection Process |

| | |
|---|---|
| 2> | else |

| | |
|---|---|
| 3> | consider itself to not be configured to execute the type-1_SL-PRS and type-2_SL-PRS Selection |
| | Process. |

| 1> | else: | |
|---|---|---|
| | 2> | consider itself to be configured to not suspend the Switch Process immediately after handover; |

..... Remaining text of 5.3.5.9 removed for brevity....

### CROSS REFERENCE

This Nonprovisional application claims priority under 35 U.S.C. § 119 on provisional Application No. 63/388,976 on Jul. 13 2022, the entire contents of which are hereby incorporated by reference.

What is claimed is:

1. A terminal device for resolving contention between first periodic data and second periodic data being transmitted by the terminal device in a New Radio (NR) system, the terminal device comprising:
one or more non-transitory computer-readable media storing a set of computer-executable instructions; and
at least one processor coupled to the one or more non-transitory computer-readable media and configured to execute the set of computer-executable instructions to:
determine whether contention will exist between transmission of the first periodic data and transmission of the second periodic data in a transmission resource; and
when contention will exist between transmission of the first periodic data and transmission of the second periodic data in the transmission resource,
select one of the first periodic data or the second periodic data for transmission in the transmission resource, and
transmit the selected one of the first periodic data or the second periodic data in the transmission resource.

2. The terminal device of claim 1, wherein:
the first periodic data comprises a Type-1 sidelink positioning reference signal (Type-1_SL-PRS); and
the second periodic data comprises a Type-2 sidelink positioning reference signal (Type-2_SL-PRS).

3. The terminal device of claim 1, wherein:
the first periodic data has a first periodicity of a first number of slots; and
the second periodic data has a second periodicity of a second number of slots that is different from the first number of slots.

4. The terminal device of claim 1, wherein:
the transmission resource comprises a same resource element of a same symbol of a same slot of a same subframe of a same radio frame in which the first periodic data and the second periodic data are configured to be transmitted.

5. The terminal device of claim 1, wherein:
the first periodic data is configured to be transmitted in the transmission resource by a first configured grant (CG); and
the second periodic data is configured to be transmitted in the transmission resource by a second CG.

6. The terminal device of claim 1, wherein:
determining whether contention will exist between transmission of the first periodic data and transmission of the second periodic data in the transmission resource comprises determining whether the first periodic data and the second periodic data are configured by a base station to be transmitted in the transmission resource, and
contention will exist when the first periodic data and the second periodic data are configured by the base station to be transmitted in the transmission resource.

7. The terminal device of claim 1, wherein:
determining whether contention will exist between transmission of the first periodic data and transmission of the second periodic data in the transmission resource comprises at least one of:
determining whether the first periodic data and the second periodic data are configured by a base station to be transmitted in the transmission resource, or
determining whether the first periodic data and the second periodic data are available in the terminal device for transmitting in the transmission resource; and
contention will exist when:
the first periodic data and the second periodic data are configured by the base station to be transmitted in the transmission resource, and
the first periodic data and the second periodic data are available in the terminal device for transmitting in the transmission resource.

8. The terminal device of claim 1, wherein selecting one of the first periodic data and the second periodic data for transmission in the transmission resource comprises:
selecting the first periodic data when a first Quality of Service (QoS) associated with the first periodic data is greater than a second QoS associated with the second periodic data; and
selecting the second periodic data when the first QoS associated with the first periodic data is not greater than the second QoS associated with the second periodic data.

9. The terminal device of claim 1, wherein selecting one of the first periodic data or the second periodic data for transmission in the transmission resource is based on selection process configuration data.

10. The terminal device of claim 9, wherein the selection process configuration data comprises configuration data provisioned in the terminal device during a manufacturing of the terminal device.

11. The terminal device of claim 9, wherein the selection process configuration data comprises configuration data transmitted by a base station to the terminal device.

12. The terminal device of claim 11, wherein the configuration data transmitted by the base station comprises configuration data carried in an RRCReconfiguration message.

13. The terminal device of claim 11, wherein the configuration data transmitted by the base station comprises configuration data carried in an otherConfig information element (IE) of an RRCReconfiguration message.

14. The terminal device of claim 9, wherein the selection process configuration data comprises a directive to always select the first periodic data.

15. The terminal device of claim 9, wherein the selection process configuration data comprises a directive to always select the second periodic data.
